(19) United States
(12) Patent Application Publication
(10) Pub. No.: US 2020/0093123 A1
(43) Pub. Date: Mar. 26, 2020

(54) INSECTICIDAL EMULSION

(71) Applicant: EVOLVA SA, Reinach (CH)

(72) Inventors: Roderick Stephen BRADBURY, North Saanich (CA); Jean Davin AMICK, Lexington, KY (US)

(21) Appl. No.: 16/465,831

(22) PCT Filed: Nov. 30, 2017
(86) PCT No.: PCT/EP2017/081076

§ 371 Date: May 31, 2019

Related U.S. Application Data
(60) Provisional application No. 62/428,896, filed on Dec. 1, 2016.
(60) Provisional application No. 62/445,486, filed on Jan. 12, 2017.

(51) Int. Cl. A01N 25/04; A01N 35/06; A01N 31/02

(52) U.S. Cl. CPC A01N 25/04; A01N 31/02; A01N 35/06

(57) ABSTRACT

The invention relates to compositions and methods for repelling, knocking down, or killing pests or ectoparasites, such as mosquitoes.

### BACKGROUND OF THE INVENTION

### Field of the Invention

This disclosure relates to repellency, knockdown and/or killing of pests or ectoparasites. In particular, this disclosure relates to the use of emulsions or micro-emulsions to repel, knock-down, and/or kill pests or ectoparasites in at least one stage of their life cycle. Preferably, the emulsion and/or micro-emulsion compositions also comprise nootkatone or a derivative thereof.

### Description of Related Art

Pest control (e.g., repellence, knock-down, and killing of pests) is a significant challenge due to the number of different pest species and their adaptability. Target pests include, for example, arthropods (such as insects), worms, parasitic organisms, fungi, bacteria, and plants.

Of particular concern are pests and parasites, including ectoparasites, that breach the outer defenses of their host to feed or breed and may be responsible for transferring diseases between successive hosts and/or creating lesions in the host outer defenses (e.g., skin). Such lesions can render the host prone to infection by viruses, bacteria or fungi. The principle of disease transmission by pests or parasites is the same, whether the hosts be humans, domestic or farm animals, birds, fish or plants. In many aspects the spread of the disease may have economic consequences as well as health issues for the individual host or population of hosts affected.

Another concern is sap-sucking insects. Sap-sucking insects puncture cell walls of buds, fruit, leaves, shoots and stems of plants and suck up plant cell contents either directly or indirectly following injection of enzymes to assist in extraction. Not only does this feeding process damage plants, but sap-sucking insects can transmit diseases to the plants during feeding. Such pests are capable of very rapid infestation and are the cause of significant damage and waste in the agricultural system by directly introducing phytopathogenic, facultative saprophytic or saprotrophic microbes in propagated plants, or propagated plant part, or by creating surface lesions making the plant or plant part more susceptible to infection.

Crustacean parasites of fish, amphibians and invertebrates (including larger crustaceans such as mollusks, shrimps and crabs) include copepods, branchiurans, tantlocarids, amphipoda, isopods and rhizosephalans. Crustacean ectoparasites (external parasites) of fish feed on mucus, epidermal tissue, and blood of hosts. They have been reported as inducing negative effects on host activity, shoaling behavior, growth rates, damaging host integument (via attachment, feeding, injection of enzymes), eliciting inflammatory immune responses, eliciting cortisol-mediated stress responses, acting as vectors and causing secondary infections. Of overriding interest to fish farmers, Lepeophtheirus salmonis (salmon louse) is a sea louse that parasitizes numerous salmon species including the widely farmed Atlantic salmon (Salmo salar). However, the salmon louse can parasitize other salmonids to varying degrees, including all species of Pacific salmon, brown trout, sea trout (Salmo trutta), and Arctic char (Salvelinus alpinus). Lepeophtheirus pectoralis is a sea louse that uses salmon and flatfish, including plaice and European flounder, as hosts. Caligus elongatus parasitizes over 80 species of marine fish, including salmon, lumpfish, saithe, pollock, sea trout, herring, Atlantic cod, and char.

The ability of crustacean ectoparasite species (such as sea lice and fish lice) to parasitize across species means that there is considerable concern that large fish farms may be infecting wild fish populations in the same waters. Indeed, there have been reports that increased rates of sea louse infection on wild fish have been found close to areas of intensive fish farming.

Sea lice infections cause a generalized chronic stress response in fish, possibly because sea louse feeding and attachment changes host mucus consistency and causes epithelial damage, which results in blood and fluid loss, electrolyte changes, and cortisol release. Whilst the release of stress hormones in the host is likely, in part, due to the above suggested mechanism and the physical pain of the lesion, there is also evidence that some sea louse species introduce active agents into their host during attachment or feeding. For example, Lepeophtheirus salmonis secrete large amounts of trypsin into their host's mucus, presumably to assist in feeding and digestion. The systemic introduction of such a broad specificity endopeptidase into host fish induces poorly understood adverse reactions. In the case of Pacific salmon, Coho, chum, and pink salmon (O. kisutch, O. keta, and O. gorbuscha, respectively), inflammation and strong immune responses are observed in tissues to which L. salmonis has attached. Such immune responses by the host fish can but does not always lead to successful rejection of the parasite within the first week of infection. Indeed, some sea lice secretions have been shown to contain prostaglandin E2 (a suppressor of T cell receptor signaling), and CYP P450s and serpins (another type of defensive enzyme) were down-regulated in host fish, especially in skin tissue, after infection. It is postulated that the downregulation of the host immune response not only leads to subsequent infectious disease, but also results in reduced growth and performance.

The Argulidae family of fish lice is one of several families of copepod crustaceans parasitic to fishes. There are hundreds of species of fish lice, with current estimates of 175 species in 1 genus, the Argulidae. An example species is Argulus foliaceus, often referred to as the common fish louse, which is considered to be one of the most widespread crustacean ectoparasites of freshwater fish in the world. Argulus foliaceus is 5 mm by 7 mm when fully grown and has been recorded on virtually every freshwater fish species within its range (Walker et al., 2007. “Size matters: stickleback size and infection with Argulus foliaceus” Crustaceana 80(11), 1397-1401). Notable food, sport and ornamental hosts include salmon, trout, sunfish, carp, bream, goldfish, pike, perch, roach, rudd, catfish, zander, tench, frogs and toads (Pasternak et al., 2000. “Life history characteristics of Argulus foliaceus L. (Crustacea: Branchiura) populations in Central Finland”. Annales Zoologici Fennici 37(1), 25-35). Fish lice in the genus Argulus attach to hosts using two suction cups in the head and hooked appendages on the body. The host skin is pierced using a stylet to feed on the blood and digestive enzymes are injected into the flesh. These wounds often become infected with bacteria and fungi, but the fish louse is also acknowledged as a specific vector for Skrjabillanidae nematodes, viruses (such as Rhabdovirus carpio), flagellates, bacteria, and fungi. Although Branchiurans are generally freshwater ectoparasites of fishes, Argulus infestations have been reported to cause mortality in farmed marine salmonid stocks in Chile and Canada.

Common symptoms of infestation include inflammation of the skin, open hemorrhaging wounds, anemia, loss of appetite, reduced growth, increased production of mucus, loss of scales, and corrosion of the fins. On larger fish, the parasite load in entire populations of host fish has been reported in the hundreds and even 1000 lice per fish. Such heavy infestations in commercial fish stocks (such as for food, sport or breeding of ornamental fish) has been reported in the industry as resulting in large financial losses and temporary closure of the aquaculture to allow for quarantine and thorough attempts at treatment.

Ectoparasites and pests may also indirectly cause nuisance, discomfort or disease to humans, animals, birds or fish. For example, many studies link the presence of dust mites with occurrence of allergic rhinitis and/or asthma. The American College of Asthma, Allergy and Immunology has estimated that approximately 10 percent of Americans exhibit allergic sensitivity to dust mites, whilst the National Institute of Environmental Health Services has estimated that 18% to 30% of Americans are allergic to dust mites' waste products. There is a genetic predisposition to dust mite allergy, but sensitivity can also develop over time. Therefore, treating and preventing dust mite infestations are of particular interest to families having members suffering from or prone to breathing issues, allergies, and asthma.

Many compositions have been developed to repel, knock-down, and/or kill pests. Yet, due to the large number of different species and often limited scope of effect of repellent compositions against any one pest, current repellent compositions are insufficient for current needs. For example, DEET (N,N-Diethyl-meta-toluamide) is effective at repelling mosquitoes when applied to an individual's skin or clothing, but DEET is perceived by many to have a strong “chemical” smell at the concentrations typically used, and this perception cannot be remedied by lowering the DEET concentration without losing antipest efficacy. As another example, permethrin is an insecticide used to combat mosquitoes. However, mosquitoes have reportedly begun developing resistance to permethrin. Moreover, the World Health Organization reports that malaria-carrying mosquito insecticide resistance is already widespread (Malaria vector insecticide resistance: Compendium of national indicator definitions, World Health Organization, August 2015, pages 1-20).

In response to such limitations of current synthetic pesticides and pest repellents, there is an interest in developing nature-derived active ingredients that are effective in the repellence, knock-down, or killing of pests. However, these active ingredients may be present at very low concentrations in natural compositions, or may be present in physical states (such as a component of a natural gum, a solid, or a plant oil) that make the natural compositions and high purity derivatives thereof unsuitable for broad application in effective methods of pest treatment and repellence. Although recombinant technologies and downstream processing have been used to produce very highly concentrated compositions comprising such nature-derived active ingredients, there remains a need to develop non-toxic formulations that are effective in the repellence, knock-down, and/or killing of pests.

### SUMMARY OF THE INVENTION

It is against the above background that the present invention provides certain advantages and advancements over the prior art. In particular, as set forth herein, the use of compositions against pests is disclosed.

Provided herein are effective compositions including at least one nature-derived active ingredient and methods of their use to repel, knock down or kill pests or ectoparasites.

Although the invention disclosed herein is not limited to specific advantages or functionalities, the invention provides nature-derived active ingredients effective in the repellence, knock-down and/or killing of pests in compositions suitable for use in effective methods of application to surfaces, objects and environments to be treated.

In some aspects, the compositions and methods disclosed herein are effective in providing a short term pesticide and/or pest knock-down activity and a longer term repellence of pests.

In some aspects, the compositions disclosed herein are effective in providing a short term pesticide and/or knock-down activity and a longer term repellence of pests resulting from nootkatone remaining on the object or surface treated with the composition.

In one embodiment, the composition is applied periodically, for example about once per day, twice per day, three times per day, four times per day, or more than four times per day. In another embodiment, the composition is applied about once every hour, once every two hours, once every three hours, once every four hours, once every five hours, once every six hours, once every seven hours or more.

In another embodiment, the composition is applied sporadically, for example about once per day, about once every 3 days, about once per week, about twice per week, about once per two weeks, about once per month, about once per two months, or about once per three months, or about once per season. In another embodiment, the composition is applied using a dispenser.

In one embodiment, the composition is applied following washing, cleaning, bathing, dipping, dunking, or immersing the surface or object to be treated.

In one aspect, an emulsion suitable for use as a pesticide or pest repellent includes (a) between about 6% and about 99% w/w hydrophobic solvent, (b) between about 4% and about 99% w/w hydrophilic solvent, (c) between about 1% and about 30% w/w surfactant, and (d) between about 0% and about 99% w/w water. In one embodiment, the emulsion can include (a) between about 6% and about 25% w/w hydrophobic solvent, (b) between about 5% and about 20% w/w hydrophilic solvent, (c) between about 10% and about 20% w/w surfactant, and (d) between about 60% and about 80% w/w water. The emulsion can be a micro-emulsion capable of killing and/or repelling at least 90% of a target pest or ectoparasite selected from at least one of a nematode, a mosquito, a gnat, a house fly, a horse fly, a tick, a tsetse fly, a blowfly, a screw fly, a bed bug, a flea, a louse, a fish louse, a sea louse, an aphid, a thrip, an arachnid, a termite, a silverfish, an ant, a cockroach, a locust, a fruit fly, a wasp, a hornet, a yellow jacket, a scorpion, a chigger, a mite or a dust mite. In one embodiment, the hydrophobic solvent can be selected from at least one of a paraffinic and/or an iso-paraffinic hydrocarbon, isopropyl myristate, isopropyl palmitate, pentyl propionate, and a methyl ester of vegetable oil. In one embodiment, the hydrophilic solvent can be at least one hydrophilic solvent selected from isopropyl alcohol, ethanol, methanol, octyl alcohol, decyl alcohol, tetrahydrofurfuryl alcohol, benzyl alcohol, a glycol, glycerol, propylene carbonate, N-methyl pyrrolidone, g-butyrolactone and dipropylene glycol monomethyl ether. In one embodiment, the surfactant can be at least one non-ionic emulsifier selected from at least one of castor oil ethoxylate, alcohol ethoxylate, glycol ethoxylate, lanolin ethoxylate, fatty acid ethoxylate, sorbitan esters of fatty acids, alkyl dimethyl amine oxides, alkyl phenol ethoxylates, alkyl ether ethoxylates and alkyl glucosides, or a blend of the at least one non-ionic emulsifier with at least one ionic emulsifier selected from sodium lauryl sulfate, sodium dodecylbenzene sulfonate, sodium laureth sulfate, sodium dioctyl sulfosuccinate, metal salts of nonylphenol ethoxylate sulfate, ammonium nonylphenol ethoxylate sulfate, nonylphenol POE 10 phosphate ester, diethanolamine alkyl sulfate and triethanolamine alkyl sulfate. In one embodiment, the emulsion can include at least one of a preservative, an antioxidant, a co-solvent or a co-surfactant. In another embodiment, the emulsion can include a sesquiterpene or a derivative thereof. In a further embodiment, the emulsion can further include nootkatone or a derivative thereof at between about 0.01% w/w and about 20% w/w. In one embodiment, the emulsion can include a viscosity modifier. In one embodiment, a method of treating or preventing pest or ectoparasite infestation including applying the emulsion to a surface. In one embodiment, the surface is at least one of a plant, a portion of a plant, a harvested plant material, skin, hair, fur, scales, feathers, an article of clothing, a collar, a shoe, furniture, bedding, a net, a table, a bench, a desk, a pathway, a carpet, a floor board, a head board, a curtain, a window sill, a mantelpiece, a work surface, a door, a wall molding, a wall, a sheet of glass, or any surface of a vehicle, a tent, a wall, a floor, a waste bin, a water surface, an edge of a water body, or a surface of an object that can create a pool of water. In one embodiment, the pest or ectoparasite is selected from at least one of a nematode, a mosquito, a gnat, a horse fly, a tick, a tsetse fly, a blowfly, a screw fly, a bed bug, a flea, a louse, a sea louse, an aphid, a thrip, an arachnid, a termite, a silverfish, an ant, a cockroach, a locust, a fruit fly, a wasp, a hornet, a yellow jacket, a scorpion, a chigger, a mite or a dust mite. In one embodiment, the emulsion is applied to the area, surface, object, pest breeding site, or material by an aerosol container with a spray nozzle, a spray gun, a pump sprayer, a trigger sprayer, a pressurized spraying device, a sponge, a brush, a roller, an irrigation spray, or a crop duster helicopter or airplane. In one embodiment, it is contemplated to use the emulsion to repel, knock-down, paralyze, kill or cause a lack of progression into at least one stage of the life cycle of a pest or ectoparasite. In another embodiment, it is contemplated to use the emulsion to repel, knock-down, paralyze, kill or cause a lack of progression into at least one stage of the life cycle of a pest or ectoparasite, wherein said pest or ectoparasite is selected from at least one of a nematode, a mosquito, a gnat, a horse fly, a tick, a tsetse fly, a blowfly, a screw fly, a bed bug, a flea, a louse, a sea louse, an aphid, a thrip, an arachnid, a termite, a silverfish, an ant, a cockroach, a locust, a fruit fly, a wasp, a hornet, a yellow jacket, a scorpion, a chigger, a mite or a dust mite. In one embodiment, it is contemplated that use of the emulsion or micro-emulsion comprising nootkatone or a derivative thereof causes repellence, knock-down, paralysis, death, or lack of progression into at least one stage of the life cycle of the pest or ectoparasite within the first minute of application, and wherein following evaporation of the solvents, surfactants and water of the composition from the treated surface or object, the nootkatone remaining on the treated surface or object causes repellence, knock-down, paralysis, death, or lack of progression into at least one stage of the life cycle of the pest or ectoparasite for at least 10 days following application of the emulsion or micro-emulsion comprising nootkatone.

These and other features and advantages of the present invention will be more fully understood from the following detailed description taken together with the accompanying claims. It is noted that the scope of the claims is defined by the recitations therein and not by the specific discussion of features and advantages set forth in the present description.

### BRIEF DESCRIPTION OF THE DRAWINGS

FIG. 1 illustrates a biosynthetic pathway for nootkatone;

FIG. 2 shows the results of treating Anopheles quadrimaculatus larvae by spraying a formulation that has a composition within the ranges set forth in Table No. 1 into a glass container prior to introduction of water and larvae; mortality was measured 12 hours after treatment;

FIG. 3A shows the rapid killing of Aedes aegypti adults after treatment with a single spray of formulation #513 disclosed herein versus a commercially available control product;

FIG. 3B shows the knockdown of Aedes aegypti adults after treatment with a single spray of formulation #513 versus a commercially available control product;

FIG. 4A shows the rapid killing of Aedes aegypti adults after treatment with a single spray of one of formulations #605, 607, 620, 621, 622, and 623 disclosed herein versus a commercially available control product;

FIG. 4B shows the knockdown of Aedes aegypti adults after treatment with a single spray of one of formulations #605, 607, 620, 621, 622, and 623 versus a commercially available control product;

FIG. 4C shows the rapid killing of Aedes aegypti adults after treatment with a single spray of one of formulations disclosed herein #640, 641, 642, and 643 versus a commercially available control product;

FIG. 4D shows the knockdown of Aedes aegypti adults after treatment with a single spray of one of formulations #640, 641, 642, and 643 versus a commercially available control product;

FIG. 5A shows the rapid killing of adult house flies after treatment with a single spray of formulation #513 versus a commercially available control product. Killing was complete 10 minutes after treatment;

FIG. 5B shows the knockdown of adult house flies after treatment with a single spray of formulation #513 versus a commercially available control product. Killing was complete 10 minutes after treatment;

FIG. 6 shows the landing repellency and probing repellency of formulations #579 and #580 versus 20% DEET or an untreated control one hour after application of the formulations to a collagen membrane;

FIG. 7 shows the landing repellency and probing repellency of formulations #605, 606, 607, 609, 614, 616 and #618 versus 20% DEET or an untreated control one hour after application of the formulations to a collagen membrane;

FIG. 8 demonstrates that a concentration of 0.03% nootkatone/1% ethanol killed 100% of Aedes aegypti larvae within 24 hours when larvae were added to treated water 3-7 days after the water was treated.

FIG. 9A shows the 30 minute knockdown and 24 hour mortality responses of the New Orleans strain of Aedes aegypti in response to treatment with a series of concentrations of nootkatone residue on the surface of a glass container;

FIG. 9B shows the 30 minute knockdown and 24 hour mortality responses of the Kisumu strain of Anopheles gambiae in response to treatment with a series of concentrations of nootkatone residue on the surface of a glass container; and

FIG. 10 demonstrates the increased landing repellency of formulations with five different enhancers (#624-628) compared to a composition with nootkatone at the same concentration without enhancer (#605).

FIG. 11 demonstrates the visual difference of exemplar emulsions (1 and 3, relatively opaque, 2 separated into two layers of varying opacity) versus micro-emulsions (4, transparent with a blue tint).

FIG. 12 demonstrates the increased landing and probing repellency of formulations with varying ratios of nootkatone, solvent, and enhancer geraniol (#660-665) compared to a composition without nootkatone, solvent or enhancer (#666).

### DETAILED DESCRIPTION OF THE INVENTION

All publications, patents and patent applications cited herein are hereby expressly incorporated by reference for all purposes.

Before describing the present invention in detail, a number of terms will be defined. As used herein, the singular forms “a,” “an,” and “the” include plural referents unless the context clearly dictates otherwise. For example, reference to a “surface” means one or more surfaces. Moreover, as used herein, when the pluralized form of any word is used herein, unless otherwise indicated, the singular form of the word is contemplated. For example, reference to “plants” can contemplate a single “plant.”

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

As used herein, the term “derivative” refers to a molecule or compound that is derived from a similar compound by some chemical or physical process.

As used herein, the terms “surface”, “area” and “object to be treated” interchangeably refer to any pest or pest-rich environment, any pest breeding site, a surface area and/or material that pests may attempt to traverse or inhabit, or are surfaces and objects on which pests can be observed or could act as vectors for their transportation. Examples of surfaces include, without limitation, plants, portions of plants, harvested plant material, skin, hair, fur, scales, feathers, clothes, collars, shoes, furniture, bedding, nets, tables, benches, desks, pathways, carpets, floor boards, head boards, curtains, window sills, mantelpieces, work surfaces in home or office, doors, wall moldings, walls, sheets of glass, or any surface of a vehicle, curtains, tents, walls, floors, water surfaces (e.g., of ponds, lakes, canals, creeks, ditches, gutters, irrigation channels, drainage channels, or marshy areas), the edges of water bodies (e.g., shorelines, pool liners and/or covers, banks, etc.), and the surfaces of objects that can create a pool of water (e.g., animal troughs, ornamental ponds, swimming pools, catch basins, paddling pools, rain barrels, gutters, or any surface of equipment, or tools used in conjunction with any of the aforementioned objects (e.g., a tool used to handle or transport plant or agricultural material). Such surfaces can comprise wood, metal, plastic, cotton, wool, silk, satin, nylon, polypropylene or any fabric suitable for use in agriculture, forestry, transport, clothing, bedding or furniture.

As used herein, the terms “plant,” “plant part,” “portion of a plant,” “plant portion,” and “crop” are used interchangeably and refer, for example, to whole plants, plant extracts, plant surfaces, leaves, roots, shoots, stems, buds, grain, fruits, seeds, nuts, and flowers or other plant parts of nutritional, cosmetic, aesthetic, or commercial value.

Examples of contemplated crops include but are not limited to mushrooms, potatoes, avocados, citrus fruit, apples, nectarines, raspberries, blueberries, grapes, roses, legumes, tobacco, mustard family plants, peppers, spinach, tomatoes, carrots, lettuce, corn, pears, and plums.

As used herein, the term “active ingredient” refers to a chemical compound or mixture of chemical compounds that is effective at killing, rendering immobile, preventing progression into another stage of the life cycle, or repelling pests from a treated surface during one or more life cycle stages of the pest.

As used herein, the term “enhancer” refers to a component used to improve the overall performance of an active ingredient contemplated herein.

As used herein, the term “effective concentration” refers to a concentration of an active ingredient (such as nootkatone) within a composition such that when the composition is applied to a pest or to a relevant surface or object to be treated, a pest that comes into contact with the composition is repelled and/or experiences paralysis, poisoning, neuro-muscular damage, or death. An “effective concentration” is also one that prevents egg laying or transitioning from one life cycle stage to the next.

As used herein, the term “effectively treat” refers to at least one of directly (e.g., by contacting a pest or its immediate surroundings) or indirectly (e.g., by contacting a pest breeding site or other object or surface that a pest will be affected by) repelling, knocking-down, paralyzing, poisoning, damaging neuro-muscular tissue of, killing, preventing egg laying by or transitioning from one life cycle stage to the next, or preventing the maturation of a pest or ectoparasite.

As used herein, the term “knocking-down” or “knock-down” refers to the ability of at least one active ingredient in a composition to render a pest or ectoparasite immobile. For example, a flying insect contacted with a composition comprising an effective concentration of at least one active ingredient is said to be “knocked-down” if it falls to ground and is unable to fly, even though it may be able to move body parts so it cannot be categorized as completely paralyzed. The pest's ability to move, feed, reproduce, spread disease or irritate is severely curtailed during the period in which it is knocked down. Of particular benefit is the enhanced susceptibility to predation of pests or ectoparasites experiencing knock-down.

As used herein, the term “killing” or “kill” refers to the ability of at least one active ingredient in a composition to render a pest dead. A typical way of expressing the ability of an active ingredient or composition comprising at least one active ingredient to kill a pest is with an LD₅₀ value. LD₅₀ values are species and life cycle-stage specific. LD₅₀ is understood by those skilled in this art to be an abbreviation for “Lethal Dose, 50%” or median lethal dose. LD₅₀ is the amount of an ingested or applied substance that kills fifty percent of a test sample, such as a test population of pests. A related measurement used to express the ability of an active ingredient or composition comprising at least one active ingredient to kill a pest is with an LC₅₀ value. LC₅₀ is understood by those skilled in this art to be an abbreviation for “Lethal Concentration, 50%” or median lethal concentration in air or water. LC₅₀ values are therefore specific to the medium in which they are tested, the test species and life cycle-stage of the species tested. LC₅₀ is the concentration of active ingredient in the air or water environment being tested that kills fifty percent of a test sample, such as a test population of pests present or introduced into that environment. LD₅₀ and LC₅₀ values have traditionally been measured following four hour exposures of test sample populations to the active ingredients being tested, but several studies presented herein measure the effects of compositions comprising active ingredients over much shorter time periods.

As used herein, the term “repelling” or “repel” refers to the ability of at least one active ingredient in a composition to cause a pest or ectoparasite to deviate away from or avoid a surface, object or pest breeding site treated with said composition.

As used herein, the term “short term pesticide and/or pest knock-down” refers to the ability of an active ingredient present in a composition to exhibit within one hour, preferably within thirty minutes, more preferably within fifteen minutes, more preferably within five minutes, even more preferably within one minute, most preferably within thirty seconds, at least one of repellence, knock-down, paralysis, death, or preventing progression into a life cycle stage of one or more pests that come into contact with said composition.

As used herein, the term “long term pesticide and/or pest knock-down” refers to the ability of an active ingredient present in a composition to exhibit at least one day after application, preferably at least two days after application, more preferably at least three days after application, more preferably at least four days after application, more preferably at least five days after application, even more preferably at least one week after application, most preferably at least two weeks after application, at least one of repellence, knock-down, paralysis, death, or preventing progression into a life cycle stage of one or more pests that come into contact with said composition.

As used herein, the term “sesquiterpene” refers to a recognised class of terpenes consisting of three isoprene units with empirical formula C₁₅H₂₄. Sesquiterpenes are found naturally, including in a range of plants, corals and insects, where some are notable in functioning as semiochemicals, such as, pheromones or allomones. Sesquiterpenes can be subdivided chemically into acyclic, monocyclic, bicyclic or tricyclic sesquiterpenes and their derivatives. For example, tricyclic sesquiterpenes are formed from three isoprene units. An example of an acyclic sesquiterpene is farnesene. An example of a monocyclic sesquiterpene is humulene. Examples of bicyclic sesquiterpenes include cadinenes such as caryophyllene, vetivazulene and guaiazulene. Examples of tricyclic sesquiterpenes include longifolene, copaene and patchoulol. An example of a class of sesquiterpene derivatives is sesquiterpenoids, which include the sesquiterpene lactones (sesquiterpenes additionally comprising a lactone ring) such as germacranolides, heliangolides, guaianolides, pseudoguaianolides, hypocretenolides, and eudesmanolides. Specific examples of sesquiterpene lactones include artemisin, Lactucin, desoxylactucin, lactucopicrin, lactucin-15-oxalate, lactucopicrin-15-oxalate.

As used herein, the term “pest” refers to and includes but is not limited to ectoparasites, insects or arachnids capable of acting as vectors for disease to humans, animals, birds, fish, plants or plant parts, or capable of irritating or causing economic damage thereto. Examples include but are not limited to nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites).

Many embodiments described herein relate to compositions, methods and uses effective in the treatment of pests or ectoparasites capable of acting as vectors for disease to their hosts (whether humans, animals, fish, birds or plants). Pests can also be selected as targets for treatment based upon their nuisance value (such as by forming swarms) or ability to indirectly cause disease or annoyance such as by eliciting pain or an immune response in the host. Moreover, pests can be targeted due to their association with lack of cleanliness or hygiene, for example, house flies, cockroaches, beetles, and weevils.

As used herein, the term “mosquito” refers to any mosquito species. Non-exhaustive examples include members of the genera Anopheles, Aedes, Culex, and Haemagogus. Further, the term “mosquito” refers to mosquitoes in any life cycle stage.

As used herein, the term “sap-sucking insects” refers to any sucking and/or chewing insects that infest or feed upon plants, fruit, or portions thereof. Sap-sucking insects include but are not limited to aphids and/or thrips. For example, additional sap sucking insects include scale insects, which are in the same order and suborder as aphids. Further examples include psyllids (also known as, jumping plant lice), whiteflies (which fall into Stemorryncha, in the Family Aleyroididae), leafhoppers, stink bugs, tarnished plant bugs, squash bugs, and spider mites.

As used herein, the term “aphid” refers to a single aphid and/or two or more aphids of the same or different species. As used herein, the term “aphids” refers to any aphid species, including but not limited to melon aphids, soybean aphids, black bean aphids, Pea aphids (Acyrthosiphon pisum) rose aphid (Macrosiphum rosae, or less commonly Aphis rosae), apple aphid (Aphis pomi), and green peach aphids.

As used herein, the term “thrips” refers to a single thrips and/or two or more thrips of the same or different species. As used herein, the term “thrips” refers to any thrips species, including but not limited to Thrips palmi, Thrips tabaci; Cuban laurel thrips (Gynaikothrips ficorum), Myoporum thrips, Western flower thrips, Citrus thrips, avocado thrips, Frankliniella schultzei, common blossom thrips (Thripidae), greenhouse thrips (Heliothrips haemorrhoidalis), chilli thrips (Scirtothrips dorsalis), redbanded thrips (Selenothrips rubrocinctus), melon thrips (Thrips palmi), and gladiolus thrips (Thrips simplex).

As used herein, the term “sea louse” refers to a single sea louse and/or two or more sea lice of the same or different species. Sea lice are marine ectoparasites (external parasites) that feed on mucus, epidermal tissue, and blood of host marine fish, and are often specific with regard to host genera. There are hundreds of species of sea lice, with current estimates of 557 species in 37 genera, but most are classified within two genera, Lepeophtheirus (162 species) and Caligus (268 species). Sea lice are all copepods within the order Siphonostomatoida, the Caligidae.

As used herein, the term “treatment of sea lice” refers to a process by which sea lice are at least one of killed, removed, or repelled from a host surface, such as skin, gills, scales, or other animal surface or other man-made or natural surfaces in the proximity to a host treatment population. The sea lice can be treated directly by coming into contact with a contemplated treatment composition.

As used herein, the terms “aquaculture device” or “aquaculture equipment” interchangeably refer to any device and/or apparatus employed in fish farming that either directly or indirectly contacts a fish. Examples of aquaculture devices include, without limitation, boats, nets, floats, tools, buoys, fish cages, tank walls and liners, clothing used when handling fish, such as gloves, boots, coats, waders, etc., aerators, pumps, pipes, breeding chambers, filters, filtration units, incubators, and hatcheries.

As used herein, the term “dust mite” refers to any Dermatophagoides species, a genus of sarcoptiform mites, including Dermatophagoides farinae, Dermatophagoides microceras, and Dermatophagoides pteronyssinus, but also to Euroglyphus maynei and further indicates a single dust mite and/or two or more dust mites of the same or different species. As used herein, the term “dust mite” refers to any Dermatophagoides species, a genus of sarcoptiform mites, including Dermatophagoides farinae, Dermatophagoides microceras, and Dermatophagoides pteronyssinus, but also to Euroglyphus maynei and further indicates a single dust mite and/or two or more dust mites of the same or different species.

As used herein, the term “Phytopathogenic or saprophytic microscopic” organisms and phytopathogenic microbes are used interchangeably and encompass, but are not limited to, fungi, bacteria, oomycetes, and phytoplasma that infect, grow and reproduce on propagated plants, portions thereof, or propagated plant material. As used herein, “phytopathogenic microbes” can be pathogenic to propagated plants, can be lysotrophic, or can be facultative saprophytic capable of infecting stressed or dying propagated plants, possibly in combination with plant pathogens. Examples of phytopathogenic, facultative saprophytic or saprotrophic microbes include but are not limited to microorganisms from the following classes: Ascomycetes (for example Venturia, Podosphaera, Erysiphe, Monilinia, Mycosphaerella, Uncinula, Leotiomyceta); Basidiomycetes (for example, the genera Hemileia, Rhizoctonia, Puccinia); Fungi imperfecti (for example Botrytis, Helminthosporium, Rhynchosporium, Fusarium, Septoria, Cercospora, Alternaria, Pyricularia and Pseudocercosporella herpotrichoides); Phytomyxea (for example, Plasmodiophora and Spongospora); Oomycetes (for example, Phytophthora, Pythium, Peronospora, Bremia, Plasmopara); Firmicutes (Bacilli, Clostridia, Mollicutes); Proteobacteria (Alpha proteobacteria, Beta proteobacteria, Gamma proteobacteria, Delta proteobacteria, Epsilon proteobacteria, Zeta proteobacteria); Phytoplasma, Spiroplasma, Penicillium glaucum, Botrytis vulgaris, and Oilium fructigenum.

As used herein, the term “propagated plant” includes any crop or plant that is deliberately sown, planted, transplanted, cultivated or nurtured by humans. It can refer, for example, to whole plants, field crops, fruit or nut trees, seedlings, young plants or plant seeds. The term “propagated plant material”, encompasses “material to be harvested”, “harvested material”, and the “commercially relevant portion of a crop or plant” and refers, for example, to plant extracts, shoots, sprouts, leaves, cuttings, roots, tubers, bulbs, rhizomes, grain, fruits, seeds, nuts, and flowers or other plant parts of cosmetic, aesthetic, or commercial value. Examples of contemplated crops include but are not limited to mushrooms, fruit trees and fruit plants (citrus fruit trees, lemon trees, lime trees, orange trees, grapefruit trees, apple trees, apricot trees, pear trees, plum trees, grape vines, nectarine trees, peach trees, tangerine trees, raspberry canes, blueberry bushes, pineapple plants, banana trees, strawberry plants, cherry trees, tomato plants, pepper plants, and chili bushes), cereal crops (wheat, barley, rye, oats, rice, quinoa, millet, sorghum and related species); beet (sugar and fodder beet); leguminous plants (beans, lentils, peas, and soya beans); oil crops (oilseed rape, mustard, poppies, olive trees, sunflower plants, coconut trees, castor plants, cocoa trees, groundnuts, and oil palms); cucurbits (pumpkin plants, cucumber plants, and melon plants); fiber plants (cotton, flax, hemp, and jute); vegetables (spinach, lettuce, asparagus, cabbages, carrots, onions, potatoes, broccoli, kale, and chard); the laurel family (avocado, Cinnamonum, and camphor), or plants such as maize, canola, tobacco, nuts, coffee bush, sugar cane, tea, hops, the plantain family and latex plants, and also ornamentals (flowers, shrubs, deciduous trees, conifers, roses, tulips, daffodils, and orchids).

As used herein, the term “nature-derived” refers to a chemical or compound that is equivalent and functionally indistinguishable from the same chemical or compound present in nature. Nature-derived chemicals or compounds can be produced by, for example, chemical synthesis or by recombinant technologies allowing heterologous expression of metabolic pathways in host organisms particularly suitable for use in biotechnology.

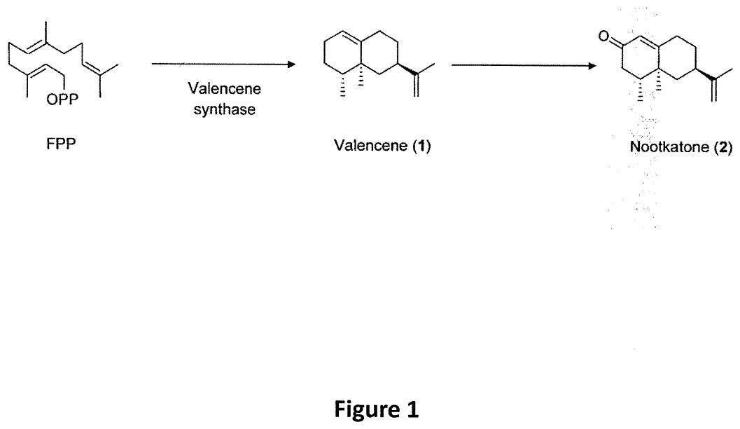

As used herein, the term “nootkatone” refers to a compound seen in FIG. 1 that can be synthesized, isolated, and purified from of a mixture of products produced in a host modified to express enzymes of the nootkatone biosynthetic pathway or that can be produced from naturally occurring sources, such as citrus plants. “Nootkatone” further refers to derivatives and analogs thereof. For example, the nootkatone compound contemplated for use herein can be produced in vivo in, inter alia, a recombinant yeast through expression of one or more enzymes involved in the nootkatone biosynthetic pathway or in vitro using isolated, purified enzymes involved in the nootkatone biosynthetic pathway, such as those described in U.S. Patent Application Publication Nos. 2015/0007368 and 2012/0246767. Therefore, nootkatone, as defined and used in the inventions disclosed herein, can differ chemically from other sources of nootkatone, such as extracts from plants and derivatives thereof, or can include such plant extracts and derivatives thereof. Preferably, the nootkatone included in nootkatone-comprising micro-emulsion compositions disclosed herein is nature-derived.

As used herein, the term “micro-emulsion” refers to a clear, thermodynamically stable, isotropic liquid mixture of one or more lipids or oils, an aqueous phase, and one or more surfactants. Depending on which phase is dispersed in which, micro-emulsions can be classified as direct (oil dispersed in water, “o/w”), reversed (water dispersed in oil, “w/o”) and bicontinuous. The micro-emulsions and emulsions described herein are oil dispersed in water (o/w) emulsions. In some aspects, micro-emulsions can comprise between about 10 and about 30% surfactant, in contrast to between about 1% and about 3% in traditional opaque emulsions. The one or more surfactants can optionally be combined with one or more co-surfactants. In some aspects, one or more co-surfactants can be added to help the primary surfactant to emulsify the oil phase in the water. The use of one or more co-surfactants allows for use of a lower overall surfactant concentration and gives better compatibility in waters of varying hardness. In aspects in which the surfactant (the primary surfactant) is anionic, then the at least one co-surfactant can be nonionic. In some embodiments, the at least one nonionic co-surfactant can be at least an alcohol ethoxylate. In aspects in which the surfactant (the primary surfactant) is nonionic, then the at least one co-surfactant can be anionic. In some embodiments, the at least one anionic co-surfactants can comprise calcium alkylbenzene sulfonates. Suitable lipids or oils include hydrocarbons, olefins and plant oils. Micro-emulsions form upon simple mixing of the components and do not require high shear conditions required to form ordinary emulsions. However, emulsions contemplated here include those formed by high shear or any other condition.

As used herein, the term “micro-emulsion” refers to an emulsion in which the mean size of the micelles or dispersed phase particles is below about 1 micron in diameter.

In some embodiments, the present invention contemplates dispersed phase particle size within emulsions or micro-emulsions according to the aspects of the current invention within the range of about 0.01 to about 1 micron.

The surfactants used to produce an emulsion or micro-emulsion can be one or more non-ionic emulsifiers, or a blend of one or more non-ionic and anionic emulsifiers. In some aspects, the emulsion or micro-emulsion comprises a blend of non-ionic and anionic emulsifiers in which the one or more non-ionic emulsifiers is present in greater amounts than the one or more anionic emulsifiers. In aspects in which water is the major solvent in an emulsion or micro-emulsion, one or more co-solvents can be utilised to enhance stability of the emulsion. The total co-solvent concentration in such aspects typically ranges from about 5% to about 50% weight/weight. In some aspects, the emulsion or micro-emulsion comprises a co-solvent blend composing a hydrophilic solvent and a hydrophobic solvent. Nonionic emulsifiers suitable for use in some aspects include but are not limited to castor oil ethoxylate (for example, Alkamuls® EL620, available from Solvay, Bruxelles, Belgium), alcohol ethoxylate, glycol ethoxylate, lanolin ethoxylate, fatty acid ethoxylate, sorbitan esters of fatty acids, alkyl dimethyl amine oxides, alkyl phenol ethoxylates, alkyl ether ethoxylates and alkyl glucosides.

Anionic emulsifiers suitable for use in some aspects include but are not limited to sodium lauryl sulfate, sodium dodecylbenzene sulfonate, sodium laureth sulfate, sodium dioctyl sulfosuccinate, metal salts of nonylphenol ethoxylate sulfate, ammonium nonylphenol ethoxylate sulfate, nonylphenol POE 10 phosphate ester, diethanolamine alkyl sulfate and triethanolamine alkyl sulfate. In some embodiments, the anionic emulsifier can be present in a weight/weight percentage of between about 2% w/w and about 50% w/w, preferably between about 4% w/w and about 40% w/w, and more preferably between about 10% w/w and about 30% w/w of emulsion. In some embodiments, the anionic emulsifier can be present at a concentration of about 10% w/w, about 15% w/w, about 20% w/w, or about 25% w/w.

Hydrophilic solvents suitable for use in some aspects include but are not limited to isopropyl alcohol (IPA), ethanol, methanol, octyl alcohol, decyl alcohol, tetrahydrofurfuryl alcohol, benzyl alcohol, glycols, glycerol, propylene carbonate, N-methyl pyrrolidone, g-butyrolactone and dipropylene glycol monomethyl ether. For example, benzyl alcohol is a clear, colourless liquid with a mild aromatic odour. It has a molecular mass of 108.14 g/mol and molecular formula C₆H₅CH₂OH. It has a low vapour pressure, is a polar solvent partially soluble in water (4 g/100 ml) and is completely miscible in alcohols. It is found naturally in the essential oils of some plants and has low toxicity (an LD₅₀ of 1.2 g/kg in rats) and is oxidized rapidly in healthy individuals to benzoic acid, conjugated with glycine in the liver, and excreted as hippuric acid. Commercially, benzyl alcohol can be used as a precursor for esters used in the flavours and fragrance industry, including perfumes and soaps. Used as a single active ingredient, it has some bacteriostatic properties. In some embodiments, the hydrophilic solvent can be present in a weight/weight percentage of between about 1% and about 30% w/w, preferably between about 2% and about 20%, more preferably between about 4% and about 12% w/w of emulsion. In some embodiments, the hydrophilic solvent may be present at a concentration of about 1% w/w, about 2% w/w, about 3% w/w, 4% w/w, about 5% w/w, about 6% w/w or about 7% w/w.

Hydrophobic solvents suitable for use in some aspects include but are not limited to paraffinic and/or iso-paraffinic hydrocarbons, isopropyl myristate (IPM), isopropyl palmitate, pentyl propionate and methyl esters of vegetable oils. For example, isopropyl myristate has a molecular mass of 270.46 g/mol and molecular formula C₁₇H₃₄O₂ and is used commercially as a solvent in the perfume industry and personal care products. In some embodiments, the hydrophobic solvent can be present in a weight/weight percentage of between about 1% and about 40% w/w, preferably between about 2% w/w and about 25% w/w, more preferably between about 6% w/w and about 18% w/w of emulsion. In some embodiments, the hydrophobic solvent can be present at a concentration of about 4% w/w, about 5% w/w, about 6% w/w, about 7% w/w, about 8% w/w, about 9% w/w or about 10% w/w.

In some aspects, a co-solvent can be included in the emulsions and micro-emulsions described herein. A co-solvent helps with dissolution of the opposing solubilities of other components in the emulsion or micro-emulsion, and also helps to lower interfacial tension between the oil phase and the water phase to facilitate formation of a very small droplet size emulsion (i.e., a micro-emulsion). In some embodiments, co-solvents can include one or more alcohols, including but not limited to at least one alcohol of carbon chain length in the range from ethanol to dodecanol inclusive.

In some aspects, the composition, emulsion or micro-emulsion can additionally comprise one or more antioxidants and/or one or more preservatives. Antioxidants reduce degradation of the active ingredient through oxidation. In some aspects, the composition, emulsion or micro-emulsion can comprise about 1% w/w antioxidant, more preferably between about 0.01% and about 0.25% antioxidant measured as weight/weight. Antioxidants suitable for use in some aspects include but are not limited to butylated hydroxy toluene (BHT), propyl gallate, butylated hydroxyanisole (BHA), tertiary-Butyl Hydroquinone (TBHQ), alpha-tocopherol, vitamin E, vitamin C, tocopherol acetate, ascorbyl palmitate and sodium L-ascorbate. In some aspects the one or more antioxidants are non-ionic or lipophilic.

Preservatives prevent microbial growth, particularly if the major solvent in the composition, emulsion or micro-emulsion is water, and multiple preservatives can be used in combination to broaden the range of control. In some aspects, the composition, emulsion or micro-emulsion can comprise between about 0.05% and about 1% (measured as weight/weight) one or more preservatives. Preservatives suitable for use in some aspects can include an antimicrobial and/or bacteriostatic, including but not limited to methyl paraben, propyl paraben, butyl paraben, iso-butyl paraben, sodium benzoate, potassium sorbate, sodium o-phenylphenate, DMDM hydrantoin, phenoxyethanol, 5-chloro-2-methyl-4-isothiazolin-3-one, diazolidinyl urea and iodopropynyl butylcarbamate. In some aspects, the one or more preservatives are ionic or hydrophilic. An example of a contemplated antimicrobial includes LiquaPar™ Optima available from Ashland Specialty Chemical, Inc. (Lexington, Ky.). A contemplated preservative includes Paragon® III, available from Solvay.

In one embodiment, the present invention contemplates the incorporation of one or more viscosity modifiers within the composition to help the composition stick or adhere to surfaces. Non-limiting examples of categories of viscosity modifiers suitable for use in some aspects of the invention are a saline, a gel, an inert powder, a zeolite, a cellulosic material, a microcapsule, an alcohol such as ethanol, a hydrocarbon, a polymer, a wax, a fat, an oil, and the like. Examples of viscosity modifiers include but are not limited to xanthan gum, guar gum, carrageenan gum, ethyl cellulose, carboxymethyl cellulose, sodium carboxymethyl cellulose, hydroxyethyl cellulose, hydroxypropylcellulose, acrylate polymers, hydrophobic silica, montmorillonite clay, magnesium aluminium silicate, smectite clay, polyvinylpyrrolidone, sodium magnesium silicate and polyacrylamide. In some embodiments the viscosity modifier is incorporated such that the nootkatone-comprising composition is retained on a surface for long enough to permit evaporation or drying, thus leaving a residue of nootkatone and optionally one or more additional active ingredients at an effective concentration to kill, knock-down or repel a pest. Thickeners can be used in widely varying concentrations depending upon the desired viscosity and the thickener type. Typical concentrations range from 0.1-10% w/w.

In one embodiment, the present invention contemplates emulsions or micro-emulsions additionally comprising one or more essential oils, including plant essential oil compounds or derivatives thereof, including but not limited to peppermint oil, lemongrass oil, wintergreen oil, rosemary oil, aldehyde C16 (pure), α-terpineol, amyl cinnamic aldehyde, amyl salicylate, anisic aldehyde, benzyl alcohol, benzyl acetate, cinnamaldehyde, cinnamic alcohol, carvacrol, carveol, citral, citronellal, citronellol, p-cymene, diethyl phthalate, dimethyl salicylate, dipropylene glycol, eucalyptol (cineole) eugenol, is-eugenol, galaxolide, geraniol, guaiacol, ionone, menthol, methyl salicylate, methyl anthranilate, methyl ionone, methyl salicylate, α-phellandrene, pennyroyal oil perillaldehyde, 1- or 2-phenyl ethyl alcohol, 1- or 2-phenyl ethyl propionate (also known as 2-phenethyl propionate), piperonal, piperonyl acetate, piperonyl alcohol, D-pulegone, terpinen-4-ol, terpinyl acetate, 4-tert butylcyclohexyl acetate, thyme oil, thymol, lavender oil, neem oil, clove extract, metabolites of trans-anethole, vanillin, and ethyl vanillin. In some aspects, the at least one essential oil is present in less than a 1:5 ratio with nootkatone, less than a 2:5 ratio with nootkatone, less than a 3:5 ratio with nootkatone, less than a 4:5 ratio with nootkatone, or about at a 1:1 ratio with nootkatone, or more than a 2:1 ratio with nootkatone, or more than a 3:1 ratio with nootkatone, or more than a 4:1 ratio with nootkatone, or more than a 5:1 ratio with nootkatone. In some aspects, the at least one essential oil is present in the emulsion or micro-emulsion at a total concentration of between about 0.5% w/w to about 10% w/w, or of between about 0.5% w/w to about 8% w/w, or of between about 1% w/w to about 4% w/w (measured as weight / weight).

As used herein, the term “about” refers to ±10% of a given value.

As used herein, unless expressly stated otherwise, percentage values in a composition are calculated as weight / weight percentages so can be expressed as % w/w.

As used herein, the terms “or” and “and/or” is utilized to describe multiple components in combination or exclusive of one another. For example, “x, y, and/or z” can refer to “x” alone, “y” alone, “z” alone, “x, y, and z,” “(x and y) or z,” “x or (y and z),” or “x or y or z.” In some embodiments, “and/or” is used to refer to components that a composition comprises, wherein a composition comprises one or components selected from a group.

### Overview

Disclosed herein are nootkatone-containing compositions and methods that effectively treat and prevent pest infestations and/or that repel pests from treated surfaces or treated objects. Disclosed herein are compositions that show efficacy against at least one life cycle stage of various pests, such as the mosquito. In particular, compositions and methods that effectively treat at least one of pest larvae, eggs, newly emerging adults, egg-laying adults, pupae, and mature adults or prevent eclosure are disclosed.

In another aspect, the current disclosure provides methods and uses for a composition comprising nootkatone suitable for treating a surface, a pest breeding site, or an environment rich in pests for preventing or delaying the onset of maturation into adulthood or reducing the overall number of mature pests emerging from the pest breeding site in one season.

Additional aspects of the current disclosure are intended to reduce or prevent the occurrence of disease transmission by ectoparasites such as mosquitoes. For example, disclosed herein are compositions and methods for preventing vector-borne pathogenic infections and include compositions capable of killing, knocking down or repelling mosquitoes in one or more stages of their life cycle. Suitable surfaces and objects to which nootkatone-containing emulsion or micro-emulsion compositions can be applied include, without limitation, skin, hair, fur, scales, feathers, vegetation, crops, propagated plant material, bushes, clothes, collars, shoes, furniture, bedding, nets, tables, benches, desks, pathways, carpets, floor boards, head boards, curtains, window sills, mantelpieces, work surfaces in home or office, doors, wall moldings, walls, wall voids, floors (e.g., the floor under furniture), waste bins, food storage areas, dark and covered areas sheets of glass, any surface of a vehicle, curtains, tents, water surfaces (e.g., of ponds, lakes, canals, creeks, ditches, gutters, irrigation channels, drainage channels, or marshy areas), stagnant water, the edges of water bodies (e.g., shorelines, pool liners and/or covers, banks, etc.), and the surfaces of objects that can create a pool of water (e.g., animal troughs, ornamental ponds, swimming pools, catch basins, paddling pools, rain barrels, gutters, or any surface of equipment, or tools used in conjunction with any of the aforementioned objects (e.g., a tool used to handle or transport plant or agricultural material). Such surfaces can comprise wood, metal, plastic, cotton, wool, silk, satin, nylon, polypropylene or any fabric suitable for use in agriculture, forestry, transport, clothing, bedding or furniture.

In some embodiments, treatment for mosquitoes can be through administration of a contemplated composition to any part of a connected water system, such as a watershed, a tributary, an irrigation system, a sprinkler system, a pool, a water fountain, a drainage system (such as a gutter), an animal watering system, an aqueduct, or any other part of a water system that can serve as a larval-stage insect breeding site. Further, administration of contemplated compositions for effective treatment of mosquitoes can be within any part of a connected water system that is in fluid communication with the remainder of the connected water system to be treated, meaning that such application will result in an added treatment composition being distributed to the remainder of the connected water system.

A further example according to some embodiments is the killing, knocking down, repellence, or detachment (whilst feeding) of a tick. Ticks are vectors for Lyme's disease. In some embodiments herein are emulsion or micro-emulsion compositions that repel ticks and/or cause feeding ticks to detach from skin or kill in situ (while feeding). In some embodiments, the emulsion or micro-emulsion compositions can further include nootkatone. Suitable surfaces to which nootkatone-containing emulsion or micro-emulsion compositions can be applied include, without limitation, skin, hair, fur, scales, feathers, clothes, collars, shoes, furniture, bedding, nets, tables, benches, desks, pathways, carpets, floor boards, head boards, curtains, window sills, mantelpieces, work surfaces in home or office, doors, wall moldings, walls, sheets of glass, any surface of a vehicle, curtains, tents, walls, or floors.

Similarly, aspects of the current disclosure are intended to reduce or prevent the occurrence of disease transmission among plants or plant parts by sap-sucking insects such as aphids or thrips. For example, disclosed herein are compositions and methods for preventing pest vector-borne plant pathogenic or saprophytic infections and include compositions capable of killing, knocking down or repelling sap-sucking insects in one or more stages of their life cycle.

In one specific embodiment, the compositions and methods described herein directly or indirectly reduce the occurrence or severity of diseases in fish by reducing the prevalence of sea lice infections that lead to or exacerbate such diseases. Examples of such diseases include salmon anemia virus, furunculosis, vibriosis, bacterial kidney disease, bacterial gill disease, yersiniosis, white spot, costiasis, ciliated protozoan parasite, kudoasis, fluke, and others.

In one embodiment, the use of nootkatone provides a sustainable and safe alternative to current insect repellents and pesticides for combatting pest infestations in an efficient, safe, and environmentally friendly manner.

In some embodiments, compositions containing nootkatone can be administered alone to effectively treat pests. In other embodiments, nootkatone-containing compositions are used in combination with other pesticides, insecticides or other treatments disclosed herein to effectively treat pests or ecto-parasites. For example, compositions including nootkatone can be administered in combination with or successively with the application of natural predators of mosquitoes. For example, natural predators of mosquitoes include dragonfly nymphs and frogs. Some pesticides known in the art are also effective in killing the natural predators of the target pest, thus reducing the long term biological control available in the area in which pesticide has been applied. However, at lower concentrations, nootkatone is not believed to have such a broad specificity on for example common insects, fish, nymphs, and frogs. Of further benefit in embodiments described herein is that pests are particularly vulnerable to predation when experiencing knock-down, such as induced by nootkatone-comprising compositions described herein.

In some embodiments, irrigation systems are contemplated that apply nootkatone-containing emulsion or micro-emulsion compositions during the process of watering plants. Examples of such irrigation systems include small systems, such as those used in private gardens and lawns and commercial systems used for commercial scale crop production facilities, such as farm fields and hydroponic facilities.

In another embodiment, the emulsion or micro-emulsion compositions disclosed herein can be applied to fields of crops, plants, plant parts or harvested plant material to prevent, treat, or reduce the frequency of an infection by phytopathogenic, facultative saprophytic or saprotrophic microbes in a propagated plant, or propagated plant part, comprising contacting the propagated plant or propagated plant part with an emulsion or micro-emulsion compositions described herein. In some embodiments the emulsion or micro-emulsion compositions can further include nootkatone.

### Compositions

Nootkatone-containing compositions contemplated herein can be formulated for direct application to a surface to effectively treat existing pest populations or as a prophylactic to repel, knock down or kill pests approaching the treated area or surface.

Generally and without limitation, contemplated compositions can be formed by the addition of emulsions or micro-emulsions described herein to water, an aqueous liquid, an oil-based liquid, a concentrated liquid, a gel, a foam, an emulsion, a micro-emulsion, a nano-emulsion, a slurry, a paint, a clear coat, a wax, a block, a pellet, a puck, a dunk, a granule, a powder, a capsule, a vesicle, an effervescent tablet, slow release tablet, an impregnated dissolvable sheet or film, an impregnated material, or combinations thereof. Further compositions can be configured for immediate release, delayed release, intermittent release, or extended release by inclusion of excipients and/or packaging structures and/or materials that enable such release profiles.

In certain aspects, the emulsions or micro-emulsions described herein are incorporated into a composition that is then formulated as a liquid or aerosol formulation suitable for application in a spray, a roll on, a dip, detergents, a foam, a cream or a lotion.

In certain aspects, a composition can be formulated for application by dispensing into or onto an area of a connected water system to be distributed throughout the system. In this context, the final composition comprising an emulsion or micro-emulsion as described herein can be provided as a solution, an emulsion, an oil, a spray, a gel, a powder, a foam, a block, a pellet, a dunk, a puck, a composition-filled dissolvable pouch, a granule, a vesicle, a capsule, and combinations thereof.

In other embodiments of the invention, compositions contemplated herein can contain any amount of nootkatone. In another embodiment, compositions contemplated herein can contain a carrier and at least about 0.001%, or at least about 0.005%, or at least about 0.01%, or at least about 0.02%, or at least about 0.03%, or at least about 0.04%, or at least about 0.05%, or at least about 0.06%, or at least about 0.07%, or at least about 0.08%, or at least about 0.09%, or at least about 0.1%, or at least about 0.2%, or at least about 0.3%, or at least about 0.4%, or at least about 0.5%, or at least about 0.6%, or at least about 0.7%, or at least about 0.8%, or at least about 0.9%, or at least about 1%, or at least about 2%, or at least about 3%, or at least about 4%, or at least about 5%, or at least about 6%, or at least about 7%, or at least about 8%, or at least about 9%, or at least about 10%, or greater than about 10%, or greater than about 15%, or greater than about 20%, or greater than about 25%, or greater than about 30%, or greater than about 35%, or greater than about 40%, or greater than about 45%, or greater than about 50%, or about 60%, or about 70%, or about 80%, or about 90%, or about 95%, or about 99% by weight nootkatone.

In one example, the provided compositions contain nootkatone in an amount at or about 0.001% to at or about 2%, or about 0.01% to at or about 5%, or about 0.01% to at or about 75% by weight of the composition. In another example, a composition can contain nootkatone in an amount of from at or about 0.25% to at or about 50% by weight of the composition. In another example, a composition can contain nootkatone in an amount of from at or about 1% to at or about 40% by weight of the composition. In another example, a composition can contain nootkatone in an amount of from at or about 5% to at or about 35% by weight of the composition. In another example, a composition can contain nootkatone in an amount of from at or about 10% to at or about 30% by weight of the composition. In another example, a composition can contain nootkatone in an amount of from at or about 1% to at or about 50% by weight of the composition. In another example, a composition can contain nootkatone in an amount of about 5%, or about 10%, or about 15%, or about 20%, or about 25%, or about 30%, or about 40% or about 50% by weight of the composition. In another example, a composition can contain nootkatone in an amount of up to about 90% or more by weight of the composition.

In one particular embodiment, a contemplated nootkatone-containing composition is provided as a concentrate. For example, a nootkatone-containing composition can be provided as a 20×, or a 10×, or a 5×, or a 3× concentrate that can be diluted by an end user with an appropriate solvent (including but not limited to water or ethanol) or by application to a connected water system or larval-stage insect breeding site to achieve a 1× (or other desired) working concentration. Alternatively, a nootkatone-containing composition can be provided to an end user at a 1× working concentration. However, any concentration is contemplated for use herein. For example, compositions provided as concentrates can be used without dilution at all or can be diluted from a highly concentrated concentrate (e.g., about 20× to about 100×, or about 30× to about 60×, or about 30×, or about 60×) to some multiple of concentration higher than 1×, such as 2×, 2.5×, 3×, etc. or can be used at a more dilute concentration, such as 1/2×, 1/4×, 1/10×, etc.

In one embodiment, a final working concentration of nootkatone applied to a surface to be treated, such as a connected water system or other pest breeding site can be about 0.01% to about 0.03% or higher.

In one embodiment, a desired final working concentration of nootkatone applied to a connected water system or pest breeding site can be determined by calculating the relative surface area of the water system or breeding site, wherein the relative surface area refers to an air-liquid interface. For example, a final working concentration can be based on percent coverage of the relative surface area, the relative thickness of nootkatone at the air-surface interface over a relative surface area, or a combination of both. Specific final working concentration examples are about 5 mmol/m², or about 10 mmol/m², about 15 mmol/m², about 25 mmol/m², about 50 mmol/m², about 60 mmol/m², about 70 mmol/m², about 80 mmol/m², about 90 mmol/m², about 100 mmol/m², or higher.

In another embodiment, a contemplated composition can be seen in Table No. 1, where ingredients can be measured in percent volume per volume, percent weight per volume, weight/weight, or percent by weight.

TABLE NO. 1
Contemplated composition formulation.

| Ingredient | Approximate % |
|---|---|
| Sesquiterpene (such as Nootkatone) | 0.0-50 |
| Solvent (such as Benzyl alcohol) | 6-99 |
| Co-solvent | 0-49 |
| Insect penetrant (such as Plant oil and/or | 0-49 |
| hydrocarbon) | |
| Antioxidant | 0-5 |
| Antimicrobial agent | 0-5 |
| Viscosity modifier | 0-15 |
| Water | 0-99 |

In one aspect, the emulsion or micro-emulsion can comprise between 6% and 18% w/w hydrophobic solvent, between 2% and 6% w/w hydrophilic solvent, between 10% and 30% w/w surfactant, between 0% and 10% nootkatone, and between 34% and 80% w/w water. In another aspect, the emulsion or micro-emulsion can comprise between 6% and 18% w/w hydrophobic solvent, between 4% and 12% w/w hydrophilic solvent, between 5% and 15% w/w surfactant, between 0% and 10% nootkatone, and between 34% and 80% w/w water. In another aspect, the emulsion or micro-emulsion can comprise between 3% and 9% w/w hydrophobic solvent, between 4% and 12% w/w hydrophilic solvent, between 10% and 30% w/w surfactant, between 0% and 10% nootkatone, and between 34% and 80% w/w water. In another aspect, the emulsion or micro-emulsion can comprise between 3% and 9% w/w hydrophobic solvent, between 2% and 16% w/w hydrophilic solvent, between 10% and 30% w/w surfactant, between 0% and 10% nootkatone, and between 34% and 80% w/w water. In more preferred aspects, the emulsions or micro-emulsions comprise between 1% and 9% nootkatone, most preferably between 2% and 5% nootkatone.

In certain embodiments, compositions contemplated herein can include nootkatone and one or more additional active ingredients. The one or more additional active ingredients can be effective against pests. In another embodiment, a contemplated composition can include one or more active ingredients against a specific life cycle stage population of pests, such as larval-stage insects, and one or more active ingredients against a different life cycle stage population, such as adult insects. In another embodiment, an additional active ingredient can have a different effective treatment profile than nootkatone (e.g., it can be life cycle stage population specific). In certain embodiments, compositions contemplated herein may include nootkatone and one or more additional active ingredients, such as DEET, a pyrethroid, or any other synthetic or natural insecticide or pesticide or repellent. Further examples of additional active ingredients include, for example, those disclosed in U.S. Pat. Nos. 6,897,244, 7,129,271, 7,629,387, and 7,939,091. An additional active ingredient may also be added to a composition in an amount of about 1% to about 30%, or about 5%, or about 10%, or about 15%, or about 20%, or about 25%, or about 30%, or about 50% by weight of the composition.

Additional active ingredients can include one or more biopesticides or biopesticide active ingredients, such as one or more of those registered with the United States Environmental Protective Agency. Additional active ingredients can also include attractants that lure larval-stage insect adults to lay eggs in a larval-stage insect breeding site that has been treated with a contemplated composition of the present disclosure. Further examples include pyrethroids, neem oil, natural plant extracts, soy oil, mineral oil, spores or metabolites of Bacillus thuringiensis israelensis, or an insect growth regulator, such as, methoprene, pyriproxyfen, or a modified triazine, such as, cyromazine, and combinations thereof. An example of mineral oil contemplated herein is Peneteck® LT available from Calumet Speciality Products (Indianapolis, Ind.).

Further examples of additional active ingredients include plant essential oil compounds or derivatives thereof. Examples include aldehyde C16 (pure), α-terpineol, amyl cinnamic aldehyde, amyl salicylate, anisic aldehyde, benzyl alcohol, benzyl acetate, cinnamaldehyde, cinnamic alcohol, carvacrol, carveol, citral, citronellal, citronellol, p-cymene, diethyl phthalate, dimethyl salicylate, dipropylene glycol, eucalyptol (cineole) eugenol, is-eugenol, galaxolide, geraniol, guaiacol, ionone, menthol, methyl salicylate, methyl anthranilate, methyl ionone, methyl salicylate, α-pheliandrene, pennyroyal oil perillaldehyde, 1- or 2-phenyl ethyl alcohol, 1- or 2-phenyl ethyl propionate, piperonal, piperonyl acetate, piperonyl alcohol, D-pulegone, terpinen-4-ol, isopropyl myristate, terpinyl acetate, 4-tert butylcyclohexyl acetate, thyme oil, thymol, lavender oil, rosemary oil, peppermint oil, neem oil, lemongrass oil, wintergreen oil, clove extract, metabolites of trans-anethole, vanillin, and ethyl vanillin.

In another embodiment, a contemplated composition can include a nootkatone to additional active ingredient ratio of about 1:10, or about 1:8, or about 1:6, or about 1:4, or about 1:2, or about 1:1, or about 2:1, or about 4:1, or about 6:1, or about 8:1, or about 10:1.

In a further example, emulsion or micro-emulsion compositions described herein can also include one or more additional active ingredients effective for repelling, knocking down or killing other insects or pests.

In other embodiments, compositions contemplated herein can include nootkatone in combination with one or more additives, such as a fragrance, a preservative, an antimicrobial, a propellant, a pH buffering agent, a UV blocker, a pigment, a dye, a surfactant, an emulsifier, a viscosity modifier such as a thickener, a solvent, a salt, an acid, a base, an emollient, a sugar, and combinations thereof. Additional additives include disinfectants and detergents. Contemplated disinfectants include quaternary ammonium compounds, phenol-based antimicrobial agents, and botanical oils with disinfectant properties.

In other embodiments, nootkatone-containing compositions can include a carrier, such as an aqueous liquid carrier, water, a saline, a gel, an inert powder, a zeolite, a cellulosic material, a microcapsule, an alcohol such as ethanol, a hydrocarbon, a polymer, a wax, a fat, an oil, a protein, a carbohydrate, and combinations thereof. Some carriers include time release materials where a nootkatone-containing composition can be released over a period of hours, or days, or weeks.

Carriers can be added to a composition in an amount of about 10%, or about 15%, or about 20%, or about 25%, or about 30%, or about 50% by weight of the composition. In some applications, a carrier can be present in an amount that is at or greater than about 60%, about 70%, about 80%, about 90%, about 95%, or about 99% by weight of the composition. In another embodiment, a carrier can be included in an amount that when added to the amount of nootkatone included in the composition amounts to 100% by volume.

In another aspect, the invention provides an emulsion or micro-emulsion composition effective against sap-sucking insects for preventing, treating or reducing an infection by phytopathogenic, facultative saprophytic or saprotrophic microbes in a propagated plant, or propagated plant part. Preferably, the emulsion or micro-emulsion composition also comprises nootkatone or a derivative thereof. In some embodiments, the composition further comprises at least one additional active ingredient that is a stilbene or a methylated or glycosylated derivative thereof, a fungicide, a fungistatin, a bactericide, a bacteriostatin, or a pesticide. For example, the active ingredients can be effective against phytopathogenic microbes including but not limited to microorganisms from the following classes: Ascomycetes (for example Venturia, Podosphaera, Erysiphe, Monilinia, Mycosphaerella, Uncinula, Leotiomyceta); Basidiomycetes (for example the genera Hemileia, Rhizoctonia, Puccinia); Fungi imperfecti (for example Botrytis, Helminthosporium, Rhynchosporium, Fusarium, Septoria, Cercospora, Alternaria, Pyricularia and, in particular, Pseudocercosporella herpotrichoides); Oomycetes (for example Phytophthora, Peronospora, Bremia, Pythium, Plasmopara); Firmicutes (Bacilli, Clostridia, Mollicutes); Proteobacteria (Alphaproteobacteria, Beta proteobacteria, Gamma proteobacteria, Delta proteobacteria, Epsilon proteobacteria, Zeta proteobacteria).

In some aspects, emulsions and micro-emulsions contemplated herein can be formulated for direct application topically to a subject in need thereof to treat or prevent infection (as a prophylactic) by pests or ectoparasites capable of acting as vectors for disease. Preferably, the emulsion or micro-emulsion composition also comprises nootkatone or a derivative thereof. In addition, compositions contemplated herein can be formulated for indirect application, such as by dispensing into or onto a zone or area of water in which the subjects are housed. A further manner of indirect application includes coating/treating aquaculture device surfaces or impregnating such aquaculture devices with nootkatone-containing compositions. In certain embodiments, a composition can be formulated for application topically on an exterior surface of a fish, for example, to the skin, gills, eyes, mouth, scales, or fins. In this context, the composition can be provided as an aerosol, a micro-emulsion, a nano-emulsion, a soap, a spray, a gel, a foam, and combinations thereof. Similarly, such topical compositions can be applied to surfaces of aquaculture devices. Nootkatone-containing compositions contemplated herein for the treatment or prevention of sea lice infestations can in some embodiments particularly benefit from the inclusion of at least one viscosity modifier.

### Methods

According to some aspects of the current invention, emulsion or micro-emulsion compositions can be directly applied to pests, pest breeding sites, or other surfaces pests can come into contact with. Preferably, the emulsion or micro-emulsion composition also comprises nootkatone or a derivative thereof. Examples of surfaces include, without limitation, skin, hair, fur, scales, feathers, clothes, collars, shoes, furniture, bedding, nets, curtains, tents, walls, floors, plants, portions of plants, harvested plant material, water surfaces (e.g., of ponds, lakes, canals, creeks, ditches, irrigation channels, or marshy areas), the edges of water bodies (e.g., shorelines, pool liners and/or covers, banks, etc.), and the surfaces of objects that can create a pool of water (e.g., animal troughs, ornamental ponds, swimming pools, catch basins, paddling pools, rain barrels, gutters, or any surface of equipment, or tools used in conjunction with any of the aforementioned objects.

According to other aspects of this invention, emulsion or micro-emulsion compositions can be applied to any mosquito, a connected water system, any mosquito breeding site, a portion of a mosquito breeding site, a surface area and/or material that mosquitoes can attempt to traverse or inhabit during any stage of their life cycle, or surfaces and objects on which mosquitoes can be observed or that could act as vectors for their transportation. Preferably, the emulsion or micro-emulsion composition also comprises nootkatone or a derivative thereof. Examples of such surfaces include, without limitation, water surfaces (e.g., of ponds, lakes, canals, creeks, ditches, irrigation channels, or marshy areas), the edges of water bodies (e.g., shorelines, pool liners and/or covers, banks, etc.), and the surfaces of objects that can create a pool of water (e.g., animal troughs, ornamental ponds, swimming pools, catch basins, paddling pools, rain barrels, gutters), or any surface of equipment, or tool used in conjunction with any of the aforementioned objects.

In a further embodiment, methods of application to a subject, surface, area or object with an effective concentration of emulsion or micro-emulsion composition as disclosed herein by liquid, spray, or wash is preferably performed in a commercial or domestic area for growing plants such as an agricultural field, forest, flowerbed, a polytunnel, greenhouse, conservatory, office, home, and/or dwelling. Preferably, the emulsion or micro-emulsion composition also comprises nootkatone or a derivative thereof.

According to another embodiment, the application to a subject, surface, area or object of an effective concentration of emulsion or micro-emulsion as disclosed herein by liquid, spray, or as a surface treatment, or wash is preferably performed in an area frequented by humans such as a communal building, workplace, home, dwelling, hotel, ferry, train, plane, bus, car, caravan, campervan, mobile home, or tent. Preferably, the emulsion or micro-emulsion composition also comprises nootkatone or a derivative thereof.

In some embodiments, emulsions or micro-emulsions disclosed herein can be administered alone to effectively treat a sap-sucking insect infestation of a plant. Preferably, the emulsion or micro-emulsion composition also comprises nootkatone or a derivative thereof. In other embodiments, nootkatone-containing emulsions or micro-emulsions are used in combination with other insecticides or other treatments disclosed herein to effectively treat a sap-sucking insect infestation of a plant. For example, emulsions or micro-emulsions comprising nootkatone can be administered in combination with or successively with the application of natural predators of sap-sucking insects to a plant in need thereof. For example, natural predators of Aphidoidea include predatory ladybirds, hoverfly larvae, parasitic wasps, aphid midge larvae, crab spiders, lacewings, and entomopathogenic fungi such as Lecanicillium lecanii and the Entomophthorales. Natural predators of thrips include, for example, Beauveria bassiana and Verticillium lecanii. Some pesticides of the art used against Aphidoidea and/or thrips are also effective in killing their natural predators, thus reducing the long term biological control available in the area in which pesticide has been applied.

Treatment for pest infestation (such as mosquito infestation) can be routine or prophylactic based on changing environmental conditions (such as raised humidity or temperature), seasonal changes (such as transitions from spring to summer to fall to winter to spring), observation of larvae, or in response to large numbers of adult pests. In some embodiments, contemplated methods include treatment with an emulsion or micro-emulsion described herein can be performed at a temperature between about 0 and about 50° C., or during a season or period of high breeding activity of pests. Preferably, the emulsion or micro-emulsion also comprises nootkatone or a derivative thereof.

According to some aspects of the current invention, the emulsion or micro-emulsion compositions described herein can be applied about once per day, about once every 3 days, about once per week, about twice per week, about once per two weeks, about once per month, about once per two months, or about once per three months, or about once per season. Preferably, the emulsion or micro-emulsion composition also comprises nootkatone or a derivative thereof.

According to some aspects of the current invention, the emulsion or micro-emulsion compositions described herein can be applied with a frequency calculated such that if a first treatment is applied to a surface area, surface or object, a second treatment can be applied to the same surface area, surface or object before the end of the adult stage of a pest as counted from the day before the first treatment was applied. Preferably, the emulsion or micro-emulsion composition also comprises nootkatone or a derivative thereof. In this manner, the first treatment is effective against at least one of adults, larvae and/or pupae of pests present at that time, and the second treatment is effective against larvae resulting from eggs laid by adult pests of the last generation immediately prior to the first treatment. If any stage of the pest life cycle is shorter than the adult stage, several treatments can be applied until the maximum time for adult stage progression has passed. For example, when a first application of nootkatone-containing emulsion or micro-emulsion is applied to a surface or mosquito breeding site on d=0, a second application of nootkatone-containing emulsion or micro-emulsion can be applied at d=15, 15 days later to treat any larvae newly hatched from eggs laid by mosquitoes that were adults when the first nootkatone-containing emulsion or micro-emulsion was applied. Optionally, additional treatments of nootkatone-containing emulsion or micro-emulsion can be applied to the surface or mosquito breeding site approximately every subsequent 15 days (e.g., d=30, d=45, d=60) and so on until the maximum adult life of the insect that emerged from a pupa the day before treatment (d=−1) has expired.

In a further aspect, a method of treating or preventing a dust mite infestation is provided that includes (a) providing an emulsion or micro-emulsion composition, (b) optionally diluting the composition to a working concentration with a liquid carrier, and (c) applying the composition to a surface. Preferably, the emulsion or micro-emulsion composition also comprises nootkatone or a derivative thereof. In one embodiment, the surface is either the surface to be treated or a surface of a dispenser. In another embodiment, the composition is a concentrate.

In a further aspect, a method of treating or preventing a pest infestation (such as a dust mite or bed bug infestation) includes (a) applying an emulsion or micro-emulsion to a reservoir comprising an aqueous solution to form a layer, a film or foam on a top surface of the aqueous solution, (b) immersing an object or dust mite rich environment to be treated into the aqueous solution, and (c) at least partially enveloping the object or dust mite rich environment with the layer, film or foam by removing the object or dust mite rich environment from the reservoir. Preferably, the emulsion or micro-emulsion composition also comprises nootkatone or a derivative thereof. In one embodiment, the object or pest-rich environment to be treated is a pillow, a stuffed toy, a duvet, bedding, or a bed mattress.

In certain embodiments, an emulsion or micro-emulsion as described herein can be formulated for application topically on an exterior surface of an individual, for example, to the lips, skin, scalp or hair. For example, the composition can be provided as an aerosol, a solution, an emulsion, an oil, a lotion, a soap, a shampoo, a conditioner, a spray, a gel, a cosmetic, a perfume, or a cologne. Preferably, the emulsion or micro-emulsion composition also comprises nootkatone or a derivative thereof.

In further embodiments, an emulsion or micro-emulsion as described herein can be formulated for application onto an exterior surface of an animal, such the fur, hair, skin, hide, and/or scalp of a human, a domesticated animal, livestock, or a pet. Preferably, the emulsion or micro-emulsion composition also comprises nootkatone or a derivative thereof.

Various methods according to some aspects of the current invention can be employed to contact fish with nootkatone-containing compositions, such methods including addition of nootkatone-containing emulsion or micro-emulsion compositions to water in which the fish are present, or to water in tanks into which the fish to be treated are introduced, or in compositions rubbed, wiped, brushed, or sprayed onto the fish to be treated, or coated onto a surface of an aquaculture device or impregnated into materials used for aquaculture devices. In one specific embodiment, the compositions and methods described herein directly or indirectly reduce the occurrence or severity of diseases in fish by reducing the prevalence of sea lice infections that lead to or exacerbate such diseases. Examples of such diseases include salmon anemia virus, furunculosis, vibriosis, bacterial kidney disease, bacterial gill disease, yersiniosis, white spot, costiasis, ciliated protozoan parasite, kudoasis, fluke, and others.

Fish to be treated for sea lice can be any fish in need thereof, including farmed fish (i.e., those grown for market) or commensalist or mutualist species cohabiting with farmed fish and/or bred by humans and introduced into fish farms, such as cleaner fish, used to support the farmed fish. In one aspect of the current invention, a population of cleaner fish (such as a wrasse species) is isolated or grown, treated with a nootkatone-comprising composition (either by surface contact such as in a bath, or by ingestion such as in feed), and then introduced into a fish farm enclosure. According to some embodiments of the current invention, nootkatone-containing compositions can be applied to fish infected by sea lice at any stage of the sea louse life cycle (such as, after the egg stage). According to some aspects of the current invention, the treatment of fish with nootkatone can be routine, prophylactic, preventative based on changed environmental conditions (such as altered sea temperature, altered current patterns, or changes in water flow rates through a fish enclosure), seasonal, or in response to the detection of an elevated incidence of sea lice in the fish farm population, the populations of adjacent fish farms, or the wild population of a native fish species.

Topical treatment of infected fish can be accomplished by netting infected fish and applying a contemplated composition by hand (brushing, spraying, sponging, dipping, etc.). Alternatively, the infected fish can be placed in a “well boat” for a “bath treatment,” where a nootkatone-containing emulsion or micro-emulsion formulation is added to the well. Use of well boats can reduce the amount of composition required, reduce some environmental concerns, and treat fish in a more uniform manner.

Alternatively, infected fish populations can be treated in situ within their tanks. In one embodiment, their tanks can be subdivided by inserting fish impervious dividing walls made of Plexiglas® or a canvas-type material into their wells to divide the treatment space into separate “baths.” Further skirts or tarpaulins can be placed around the cages to at least partially contain the applied composition.

Nootkatone emulsion or micro-emulsion compositions can be applied, such as by directly pouring the compositions into the water or placing a composition dispenser within the well, bath, or tank such that the fish to be treated come into contact with the nootkatone at an effective concentration of, for example, between 100 and 2000 ppm, preferably between 200 and 400 ppm, most preferably approximately 300 ppm. The fish can be exposed to any of the contemplated nootkatone emulsion or micro-emulsion compositions for about 15 minutes to about 24 hours. In a preferred embodiment of one aspect of the current invention, the fish are exposed to an effective amount of nootkatone, such as, at concentration of 300 ppm, for between about 15 to about 60 minutes. Alternative, the fish can be treated until such time as at least one sea louse is seen to detach or become immobile.

### Dispensers/Applicators

In some embodiments herein, emulsion or micro-emulsion topical compositions as described herein are contemplated that can be dispensed using a dispenser or applicator including one or more of a spray bottle, a brush, a dropper, a sponge, a soft-tipped marking device with reservoir, pressurized dispenser, an aerosol can, a roll on bottle, a wipe, a tissue, and other devices suitable for application to surfaces, objects, or pest-rich environments. Preferably, the emulsion or micro-emulsion composition also comprises nootkatone or a derivative thereof.

In one embodiment, emulsion or micro-emulsion compositions contemplated herein can be applied to one or more surfaces using an applicator having a reservoir for carrying a composition in a wet form. Examples of applicators that can be used include an aerosol container with a spray nozzle with or without a spray straw to focus delivery of the composition, a spray gun, a pump sprayer, a trigger sprayer, or a pressurized spraying device. Preferably, the emulsion or micro-emulsion composition also comprises nootkatone or a derivative thereof. The nootkatone-containing emulsion or micro-emulsion compositions can alternatively be applied by spraying or dispersing over at least a portion of an area susceptible to infestation by pests or ectoparasites, including but not limited to spraying from a backpack, tractor, truck, trailer, boat, irrigation spray, helicopter, crop duster or airplane.

In another embodiment, it is contemplated that a “use up cue” can be included in the contemplated dispensers, such as, for example, a beacon that gives off light and/or sound or changes color when a treatment composition has been nearly or completely used up. The use up cue can be based on a timer, in that, after a predetermined length of time that coincides with the time when the treatment composition is nearly or fully dispensed, the use up cue is triggered by the timer.

In a further embodiment, it is contemplated that the emulsion or micro-emulsion compositions provided herein can be formulated with an “application cue” such that when a contemplated composition is applied to a surface, a foam forms or transient color is seen. In this way, a user applying the emulsion or micro-emulsion compositions can see where she has applied the compositions.

Another aspect of the current invention includes pretreatment of surfaces, objects, environments prone to infestation with pests or ectoparasites, such as mosquitoes. In some aspects this can be accomplished by coating the surfaces or objects with emulsion or micro-emulsion compositions that resist removal from the surface and preferably also contain an amount of a nootkatone, such as a paint, a clear coat, a wax, an oil, an adhesive, a resin, a cleaning solution, and combinations thereof.

In another embodiment, the emulsion or micro-emulsion compositions described herein can be formulated for application to an outdoor area, such as a lawn, a flower bed, a reed bed, a forest, a field, and the like. For example, the emulsion or micro-emulsion composition can be placed in a bug bomb, or a pressurized canister adapted to dispense the composition onto a surface a radial distance of up to about 1 meter, or up to about 5 meters, or up to about 10 meters. In another example, the emulsion or micro-emulsion composition can be formulated for inclusion in a sprayer device to be connected to a water source and thereby dispensed over a large area. Preferably, the emulsion or micro-emulsion composition formulated for application to an outdoor area also comprises nootkatone or a derivative thereof.

The invention will be further described in the following examples, which do not limit the scope of the invention described in the claims.

### EXAMPLES

Positive controls used for examples: For repellency assays, 20% DEET in ethanol was used as a positive control. For killing assays, a commercially available, pyrethrum-based insecticide, Harmonix Insect Spray™, was used as a positive control. The Harmonix product (EPA Registration number 432-1526) comprises 6% pyrethrins (0.5 lb pyrethrins per gallon). The experimental formulations used in the Examples are listed in Table No. 2 below.

TABLE NO. 2
Experimental Formulations.

| Formulation # | | | | | | | |
|---|---|---|---|---|---|---|---|
| (Label) | | | | | | | |
| | ECS-F- | ECS-F- | ECS-F- | ECS-F- | ECS-F- | ECS-F- | |
| | 579 | 580 | 583 | 586 | 513 | 542 | |
| Ingredients | % | % | % | % | % | % | |
| Nootkatone | 5.0% | — | 0.5% | — | 1% | 1% | |
| Mineral Oil | — | — | — | — | — | — | |
| Isopropyl | 10.0% | 10.0% | 10% | 10% | 10% | — | |
| Alcohol | | | | | | | |
| Benzyl Alcohol | 4.0% | 4.0% | 4% | 4% | 4% | 4% | |
| Isopropyl | 6.0% | 6.0% | 6% | 6% | 6% | 6% | |
| Myristate | | | | | | | |
| Peneteck ® LT | 5.0% | 5.0% | — | — | — | — | |
| Isopar M | — | — | 5% | 5% | 5% | 88.9% | |
| BHT | 0.1% | 0.1% | 0.1% | 0.1% | 0.1% | 0.1% | |
| Alkamuls ® | 10.0% | 10.0% | 10% | 10% | 10% | — | |
| EL620 | | | | | | | |
| Liquapar ™ | 0.2% | 0.2% | 0.2% | 0.2% | 0.2% | — | |
| Optima | | | | | | | |
| Water | 59.7% | 64.7% | 64.2% | 64.7% | 63.7% | — | |
| | ECS-F- | ECS-F- | ECS-F- | ECS-F- | ECS-F- | ECS-F- | |
| | 620 | 621 | 622 | 623 | 605 | 607 | |
| Ingredients | % | % | % | % | % | % | |
| Nootkatone | 1.00% | 1.00% | 1.00% | 1.00% | 1.00% | — | |
| Benzyl Alcohol | — | 4.00% | 4.00% | 4.00% | 4.00% | 4.00% | |
| IPM | 6.00% | — | 6.00% | 6.00% | 6.00% | 6.00% | |
| IPA | 10.00% | 10.00% | — | 10.00% | 10.00% | 10.00% | |
| Peneteck ® LT | 5.00% | 5.00% | 5.00% | — | 5.00% | 5.00% | |
| BHT | 0.10% | 0.10% | 0.10% | 0.10% | 0.10% | 0.10% | |
| Alkamuls ® | 10.00% | 10.00% | 10.00% | 10.00% | 10.00% | 10.00% | |
| EL620 | | | | | | | |
| Paragon ® III | 0.20% | 0.20% | 0.20% | 0.20% | 0.20% | 0.20% | |
| Water | 67.70% | 69.70% | 73.70% | 68.70% | 63.70% | 64.70% | |
| | ECS-F- | ECS-F- | ECS-F- | ECS-F- | | ECS-F- | |
| | 609 | 606 | 614 | 616 | | 618 | |
| Ingredients | % | % | % | % | | % | |
| Nootkatone | 2.00% | 5.00% | 5.00% | 5.00% | | 5.00% | |
| Benzyl Alcohol | 4.00% | 4.00% | 4.00% | 4.00% | | 4.00% | |
| IPM | 6.00% | 6.00% | 6.00% | 6.00% | | 6.00% | |
| IPA | 10.00% | 10.00% | 10.00% | 10.00% | | 10.00% | |
| Mineral Oil | — | — | — | 5.00% | | 10.00% | |
| Peneteck ® LT | 5.00% | 5.00% | 10.00% | — | | — | |
| BHT | 0.10% | 0.10% | 0.10% | 0.10% | | 0.10% | |
| Alkamuls ® | 10.00% | 10.00% | 10.00% | 10.00% | | 10.00% | |
| EL620 | | | | | | | |
| Paragon ® III | 0.20% | 0.20% | 0.20% | 0.20% | | 0.20% | |
| Water | 62.70% | 59.70% | 54.70% | 59.70% | | 54.70% | |
| | ECS-F- | ECS-F- | ECS-F- | ECS-F- | | ECS-F- | |
| | 624 | 625 | 626 | 6276 | | 628 | |
| Lot number | ECS-36- | ECS-36- | ECS-36- | ECS-36- | | ECS-36- | |
| | 184-1 | 184-2 | 184-3 | 184-4 | | 184-5 | |
| Ingredients | % | % | % | % | | % | |
| Nootkatone | 1.00% | 1.00% | 1.00% | 1.00% | | 1.00% | |
| Benzyl Alcohol | 4.00% | 4.00% | 4.00% | 4.00% | | 4.00% | |
| IPM | 6.00% | 6.00% | 6.00% | 6.00% | | 6.00% | |
| IPA | 10.00% | 10.00% | 10.00% | 10.00% | | 10.00% | |
| Peneteck ® LT | 5.00% | 5.00% | 5.00% | 5.00% | | 5.00% | |
| Rosemary Oil | 1.00% | — | — | — | | — | |
| Peppermint Oil | — | 1.00% | — | — | | — | |
| 2-Phenethyl | — | — | 1.00% | — | | — | |
| Propionate | | | | | | | |
| Geraniol | — | — | — | 1.00% | | — | |
| Lemongrass | — | — | — | — | | 1.00% | |
| Oil | | | | | | | |
| BHT | 0.10% | 0.10% | 0.10% | 0.10% | | 0.10% | |
| Alkamuls ® | 10.00% | 10.00% | 10.00% | 10.00% | | 10.00% | |
| EL620 | | | | | | | |
| Paragon ® III | 0.20% | 0.20% | 0.20% | 0.20% | | 0.20% | |
| Water | 62.70% | 62.70% | 62.70% | 62.70% | | 62.70% | |
| | ECS-F- | ECS-F- | | ECS-F- | | ECS-F- | |
| | 640 | 641 | | 642 | | 643 | |
| Ingredients | % | % | | % | | % | |
| Nootkatone | 0.0% | 0.0% | | 0.0% | | 0.0% | |
| Benzyl Alcohol | — | 4.0% | | 4.0% | | 4.0% | |
| IPM | 6.0% | — | | 6.0% | | 6.0% | |
| IPA | 10.0% | 10.0% | | — | | 10.0% | |
| Peneteck ® LT | 5.0% | 5.0% | | 5.0% | | — | |
| BHT | 0.1% | 0.1% | | 0.1% | | 0.1% | |
| Alkamuls ® EL620 | 10.0% | 10.0% | | 10.0% | | 10.0% | |
| Paragon ® III | 0.2% | 0.2% | | 0.2% | | 0.2% | |
| Water | 68.7% | 70.7% | | 74.7% | | 69.7% | |
| Total | 100.0% | 100.0% | | 100.0% | | 100.0% | |
| | ECS-F- | ECS-F- | | ECS-F- | | ECS-F- | |
| | S1 | S2 | | S3 | | S4 | |
| Ingredients | % | % | | % | | % | |
| Nootkatone | 0.0% | 0.0% | | 0.0% | | 0.0% | |
| Benzyl Alcohol | — | 4.0% | | 4.0% | | 4.0% | |
| IPM | 6.0% | — | | 6.0% | | 6.0% | |
| IPA | 10.0% | 10.0% | | — | | 10.0% | |
| Peneteck ® LT | 5.0% | 5.0% | | 5.0% | | — | |
| BHT | 0.1% | 0.1% | | 0.1% | | 0.1% | |
| Alkamuls ® EL620 (S1, S2); | 1.0% | 2.0% | | 1.0% | | 2.0% | |
| Tween ® 20 (S3, S4) | | | | | | | |
| Paragon ® III | 0.2% | 0.2% | | 0.2% | | 0.2% | |
| Water | 77.7% | 78.7% | | 83.7% | | 77.7% | |
| Total | 100.0% | 100.0% | | 100.0% | | 100.0% | |
| | ECS-F- | ECS-F- | | ECS-F- | | ECS-F- | |
| | S5 | S6 | | S7 | | S8 | |
| Ingredients | % | % | | % | | % | |
| Nootkatone | 0.0% | 0.0% | | 0.0% | | 0.0% | |
| Benzyl Alcohol | — | 4.0% | | 4.0% | | 4.0% | |
| IPM | 6.0% | — | | 6.0% | | 6.0% | |
| IPA | 10.0% | 10.0% | | — | | 10.0% | |
| Peneteck ® LT | 5.0% | 5.0% | | 5.0% | | — | |
| BHT | 0.1% | 0.1% | | 0.1% | | 0.1% | |
| Alkamuls ® EL620 (S1, S2); | 1.0% | 2.0% | | 1.0% | | 2.0% | |
| Tween ® 20 (S3, S4) | | | | | | | |
| Paragon ® III | 0.2% | 0.2% | | 0.2% | | 0.2% | |
| Water | 76.7% | 77.7% | | 82.7% | | 76.7% | |
| Total | 100.0% | 100.0% | | 100.0% | | 100.0% | |
| | ECS-660 | ECS-661 | ECS-662 | ECS-663 | ECS-664 | ECS-665 | ECS-666 |
| Ingredients | % | % | % | % | % | % | % |
| Nootkatone | 2.0 | 2.0 | 2.0 | 2.0 | 2.0 | 2.0 | 2.0 |
| Benzyl Alcohol | 0.0 | 0.0 | 0.0 | 4.0 | 4.0 | 4.0 | 0.0 |
| Geraniol | 1.0 | 2.0 | 4.0 | 1.0 | 2.0 | 4.0 | 0.0 |
| Dodecanol | 4.0 | 4.0 | 4.0 | 0.0 | 0.0 | 0.0 | 0.0 |
| IPM | 6.0 | 6.0 | 6.0 | 6.0 | 6.0 | 6.0 | 6.0 |
| IPA | 10.0 | 10.0 | 10.0 | 10.0 | 10.0 | 10.0 | 10.0 |
| Peneteck LT | 5.0 | 5.0 | 5.0 | 5.0 | 5.0 | 5.0 | 5.0 |
| BHT | 0.1 | 0.1 | 0.1 | 0.1 | 0.1 | 0.1 | 0.1 |
| Elkamuls EL- | 10.0 | 10.0 | 10.0 | 10.0 | 10.0 | 10.0 | 10.0 |
| 620 | | | | | | | |
| Paragon III | 0.2 | 0.2 | 0.2 | 0.2 | 0.2 | 0.2 | 0.2 |
| Water | 61.7 | 60.7 | 58.7 | 61.7 | 60.7 | 58.7 | 68.7 |
| Total | 100.0% | 100.0% | 100.0% | 100.0% | 100.0% | 100.0% | 100.0% |

### Example No. 1

### Susceptibility of Mosquito Larvae to Treatment with Nootkatone Formulations

This example describes a laboratory bioassay in which groups of mosquito larvae were exposed to a nootkatone-containing composition to determine larval susceptibility to nootkatone.

The organisms used for testing are shown in Table No. 3 below.

TABLE NO. 3
Organisms used for testing.

| Name | Scientific name | Life stage/sex |
|---|---|---|
| Malaria | Anopheles | 2^{nd}/3^{rd} instar |
| mosquito | quadrimaculatus | larvae/mixed |
| | | sex |

### Treatment

One pump spray of a formulation (provides an average of 1-1.13 mL of formulation per pump) was applied directly to a clean 600 mL glass beaker, and immediately thereafter, 100 mL of water containing larvae was added by pouring. Two different formulations, #513 and #542, were tested, which are comprised of components as in Table No. 2. One set of beakers without treatment was used as a control. Three or four replicates of at least 25 larvae were tested per treatment. Clean, glass 600 mL laboratory beakers were used as test containers such that the surface area of the water to be treated was 54 cm².

### Assessments

Larvae were observed after 12 hours post-introduction to the test containers. The larvae were scored according to the following criteria:
Morbidity (M): does not swim to/from the water surface to feed and breathe or otherwise initiate directional movement, but still exhibits movement with or without tactile stimulation; or
Dead (mortality): exhibits no movement, even with tactile stimulation.

### Results

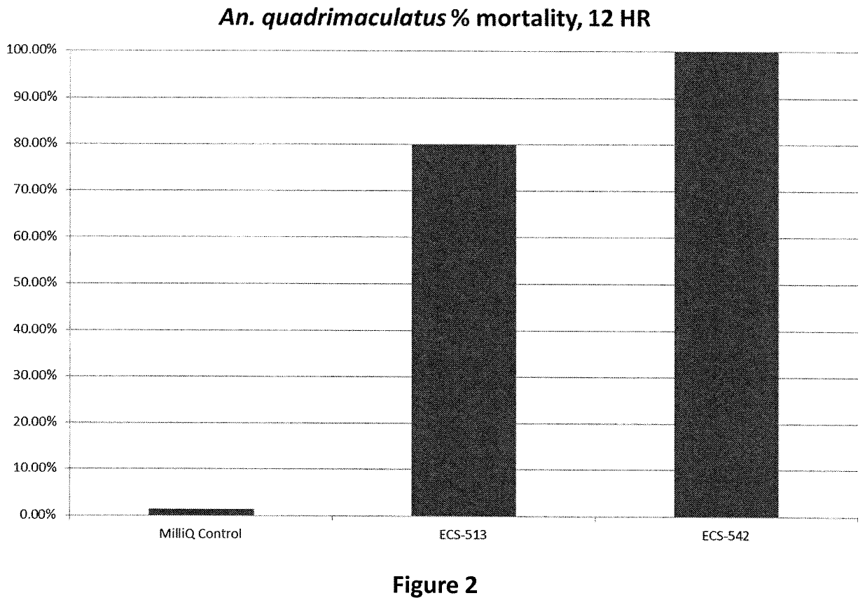

The treatment results are shown in FIG. 2. The control beakers exhibited approximately 0.01% mortality. Formulation #513 killed an average of 80% of larvae within 12 hours. Formulation #542 killed 100% of larvae within 12 hours. It is clear that formulation #542 is an effective larvicide.

### Example No. 2

### Efficacy of Exemplar Formulation for Killing and Knockdown of Adult Mosquitoes

In this example, nootkatone-containing compositions were formulated to provide knockdown and to kill when making contact with adult mosquitoes.

Preparation: The treatment arena consisted of 1.75″ dia.×0.5″ CPVC Cartridge with BioQuip® 7250NSW mesh. Twenty ounce (20 oz.) plastic cups were used as post-treatment observation areas. Food/water was supplied in the post-treatment areas via cotton balls soaked with 10% sucrose solution.

Test Setup: Adult insects were anesthetized using carbon dioxide gas, and 10 adults were placed into the treatment arena (one replicate). Insects were allowed to recover from anesthetic before treatment. Only live insects of “good vigor” were selected for testing, and insects were checked for continued vigor after transfer into the treatment arena.

Application of treatment: After insects recovered from anesthetic, they were treated with nootkatone-containing formulation #513 or with a control treatment of 0.03% Harmonix™ Insect Spray, a known insecticide that contains 6% pyrethrins as the active ingredient. Trigger sprayers that provide an average of 1 mL per pump were used to apply 1 mL of a spray mist from a distance of 12 inches from the treatment arena. Four replicates each were tested for formulation #513 and for the Harmonix™ Insect Spray control.

Observation Methods:
a. The number of “Alive”, “Knockdown (KD)”, and “Dead” Insects per arena was recorded prior to applications (Pre-trt), and at 15 sec, 30 sec, 1 min, 5 min, 10 min, 30 min, 1 hr, 2 hr, 4 hr, and 24 hr after the applications.
b. The observations were collected by raising the test arenas and gently blowing air on the insects to provoke movement, lightly prodding the insects, or the test arenas were shaken/agitated to provoke insect movement.
c. The insects were transferred from the Treatment Arenas into the clean Post-Treatment Arenas 1-hour after the applications.
d. Definitions of “Alive”, “Knockdown (KD)”, and “Dead”:
   i. Alive—Insect exhibited normal forward motion and/or the ability to fly.
   ii. Knock Down (KD)—Insect exhibited some movement, but could not crawl and/or fly.
   iii. Dead—Insect exhibited no movement, even when stimulated.

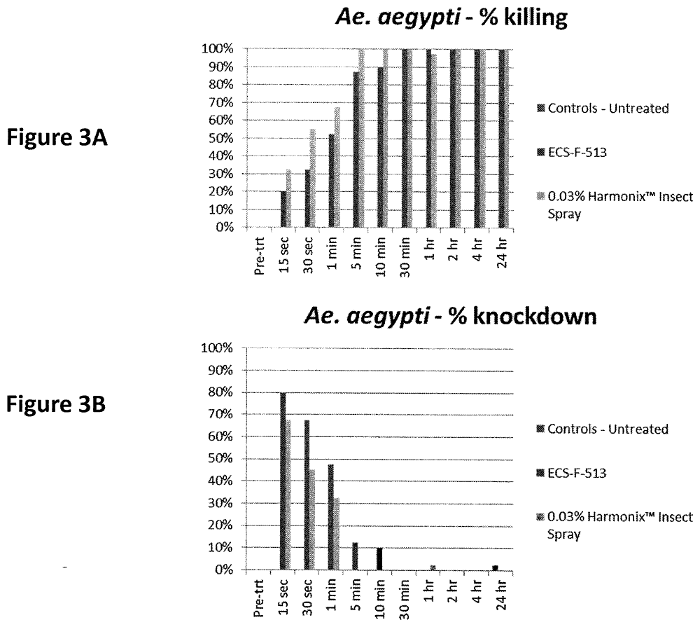

Results: FIGS. 3A and 3B provide the results of this experiment. Both formula #513 and the Harmonix™ Insect Spray positive control affect 100% of the mosquitoes within 15 seconds. Formula #513 killed 20% of the adult mosquitoes within 15 seconds, while the remaining 80% were knocked down. Observations at 30 seconds, 1 minute, 5 minutes and 10 minutes after treatment showed that the mortality rate climbed to 90% within 10 minutes, with a concomitant decrease of the percentage counted as being knocked down. All mosquitoes were dead within 30 minutes. Note that it can be difficult to detect signs of life, and 2% of the mosquitoes counted as being dead at 30 minutes showed abnormal movement at the 1 hour observation time for the Harmonix™ Insect Spray control samples.

### Example No. 3

### Efficacy of Additional Exemplar Formulations for Killing and Knockdown of Adult Mosquitoes

In this example, additional emulsion or micro-emulsion compositions were formulated to provide knockdown and killing when making contact with adult mosquitoes.

Preparation: The treatment arena consisted of 1.75″ dia.×0.5″ CPVC Cartridge with BioQuip® 7250NSW mesh. Twenty ounce (20 oz.) plastic cups were used as post-treatment observation areas. Food/water was supplied in the post-treatment areas via cotton balls soaked with 10% sucrose solution.

Test Setup: Adult insects were anesthetized using carbon dioxide gas, and 10 adults were placed into the treatment arena (one replicate). Insects were allowed to recover from anaesthetic before treatment. Only live insects of “good vigor” were selected for testing, and insects were checked for continued vigor after transfer into the treatment arena.

Application of treatment: After insects recovered from anesthetic, they were treated with one of formulations 605, 607, 620, 621, 622, 623, 640, 641, 642, 643 or with a control treatment of 0.03% Harmonix™ Insect Spray. Trigger sprayers that provide an average of 1 mL per pump were used to apply 1 mL of a spray mist from a distance of 12 inches from the treatment arena. Four replicates each were tested for each test formulation and for the Harmonix™ Insect Spray control.

Observation Methods:
a. The number of “Alive”, “Knockdown (KD)”, and “Dead” Insects per arena was recorded prior to applications (Pre-trt), and at 15 sec, 30 sec, 1 min, 5 min, 10 min, 30 min, 1 hr, 2 hr, 4 hr, and 24 hr after the applications.
b. The observations were collected by raising the test arenas and gently blowing air on the insects to provoke movement, lightly prodding the insects, or the test arenas were shaken/agitated to provoke insect movement.
c. The insects were transferred from the Treatment Arenas into the clean Post-Treatment Arenas 1-hour after the applications.
d. Definitions of “Alive”, “Knockdown (KD)”, and “Dead” are the same as in Example 2.

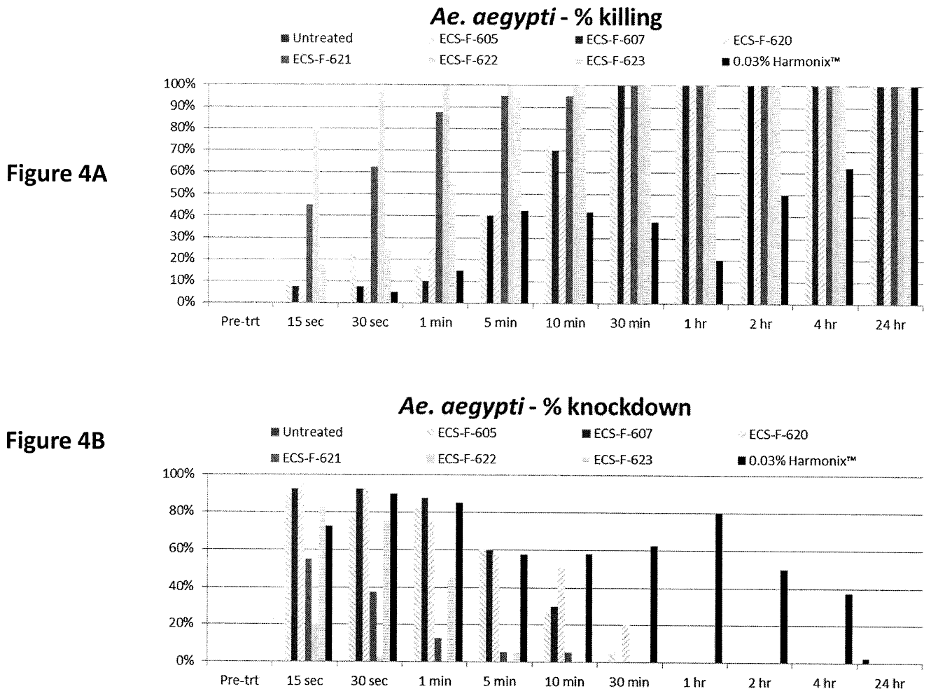

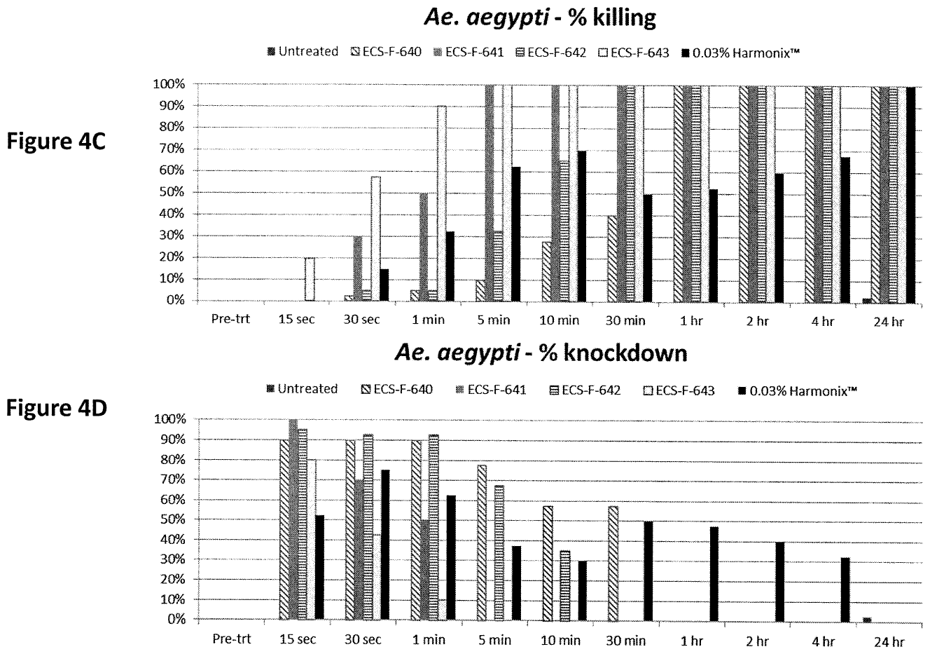

Results: FIGS. 4A-4D provide the results of this experiment. All of these formulations (605, 607, 620-623, 640-643) either knock down or kill 90-100% of the mosquitoes within 15 seconds, while the Harmonix™ Insect Spray positive control knocks down only 50-73% of mosquitoes in 15 seconds (FIGS. 4B and 4D). Formulations 605, 607, 620, 623, 641, and 643 knocked down 80-100% of the adult mosquitoes within 15 seconds, while the remaining adults were killed. Formulations 621 and 622 killed 45% and 80% of the mosquitoes within 15 seconds, respectively, while the remaining mosquitoes were knocked down. Formulations 640 and 642 knocked down 91-95% of the adult mosquitoes within 15 seconds, but the remaining adults were not killed. Observations at 30 seconds, 1 minute, 5 minutes and 10 minutes after treatment showed that the mortality rate for formulation 622 climbed to 100% within 1 minute, with a concomitant decrease of the percentage counted as being knocked down. All mosquitoes were dead within 1 hour after treatment with the test formulations, but not with the Harmonix™ Insect Spray control (FIGS. 4A and 4C). It can be difficult to detect signs of life, and although 43% of the mosquitoes were counted as being dead at 5 minutes (FIG. 4A), some previously counted as dead showed abnormal movement at the 30 minute and 1 hour observation time, for the Harmonix™ Insect Spray control samples. All of the Harmonix™ Insect Spray control samples were dead at 24 hours after treatment.

### Example 4

### Efficacy of Exemplar Formulation for Killing and Knockdown of House Flies

In this example, nootkatone-containing compositions were formulated to provide knockdown and killing when making contact with adult house flies.

Preparation: The treatment arena consisted of 1.75″ dia.×0.5″ CPVC Cartridge with BioQuip® 7250NSW mesh. Twenty ounce (20 oz.) plastic cups were used as post-treatment observation areas. Food/water was supplied in the post-treatment areas via cotton balls soaked with 10% sucrose solution.

Test Setup: Adult insects were anesthetized using carbon dioxide gas, and 10 adults were placed into the treatment arena (one replicate). Insects were allowed to recover from anaesthetic before treatment. Only live insects of “good vigor” were selected for testing, and insects were checked for continued vigor after transfer into the treatment arena.

Application of treatment: After insects recovered from anaesthetic, they were treated with nootkatone-containing formulation #513 or with a control treatment of 0.03% Harmonix™ Insect Spray. Trigger sprayers that provide an average of 1 mL per pump were used to apply 1 mL of a spray mist from a distance of 12 inches from the treatment arena. Four replicates each were tested for formulation #513 and for the Harmonix™ Insect Spray control.

Observation Methods:
a. The number of “Alive”, “Knockdown (KD)”, and “Dead” Insects per arena was recorded prior to applications (Pre-trt), and at 15 sec, 30 sec, 1 min, 5 min, 10 min, 30 min, 1 hr, 2 hr, 4 hr, and 24 hr after the applications.
b. The observations were collected by raising the test arenas and gently blowing air on the insects to provoke movement, lightly prodding the insects, or the test arenas were shaken/agitated to provoke insect movement.
c. The insects were transferred from the Treatment Arenas into the clean Post-Treatment Arenas 1-hour after the applications.
   i. Definitions of “Alive”, “Knockdown (KD)”, and “Dead” are the same as above.

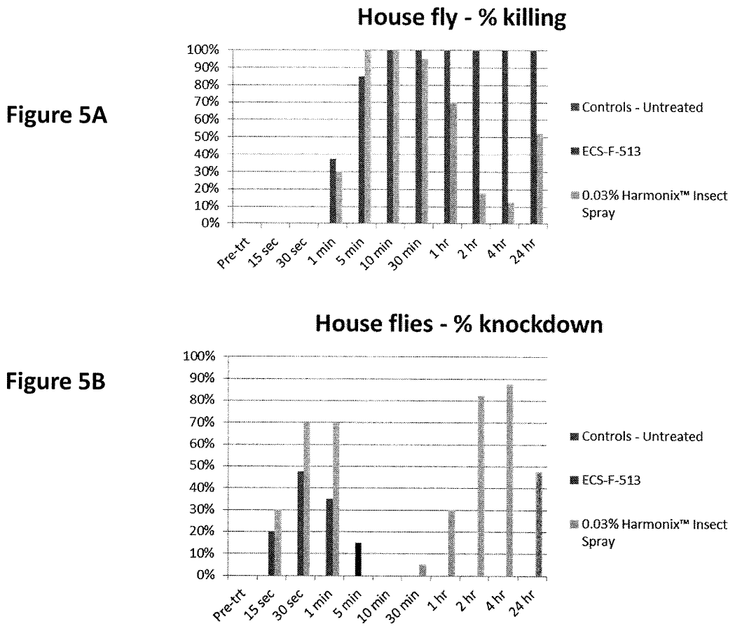

Results: FIGS. 5A and 5B provide the results of this experiment. Both formula #513 and the Harmonix™Insect Spray positive control knock down over 20% of the mosquitoes within 15 seconds. Formula #513 killed 38% of the adult mosquitoes within 1 minute, and observations at 30 seconds, 1 minute, 5 minutes and 10 minutes after treatment showed that the mortality rate climbed to 100% within 10 minutes. Note that it can be difficult to detect signs of life, and 5% of the house flies that were counted as being dead at 5-10 minutes showed abnormal movement at the 30 minute observation time for the Harmonix™ Insect Spray control samples. The Harmonix™ mortality rate dropped to 13% at the 4 hour observation point, and only 53% of the flies treated with Harmonix™ were dead after 24 hours. In contrast, once flies treated with formula #513 were counted as being dead, they did not regain movement or recover.

### Example No. 5

### Efficacy of Exemplar Formulation for Repellency of Adult Mosquitoes

In this example, nootkatone-containing compositions were formulated to provide contact repellency against adult mosquitoes.

Twenty five Aedes aegypti adult female mosquitoes were introduced into a 1 ft.×1 ft.×1 ft. cage. The mosquitoes were starved for at least 2 hours before repellency testing. The test formulation or control substance (see “Treatments”) was applied at a rate of approximately 0.3 mL onto a dampened collagen membrane (2.5 inches×6 inches) to mimic the effect of skin, and the membrane was allowed to age for one hour while resting on a damp cloth. An untreated, dampened collagen membrane was placed on a mesh opening at the top of the test cage, and a researcher's arm was suspended ˜1/4 inch above the membrane to act as an attractant. The numbers of landings and probings of the untreated membrane were counted during a 5 minute period, and these counts were used as the baseline level of activity for that specific replicate of mosquitoes. Immediately after the baseline count, an aged treated membrane was placed on top of the cage, and the numbers of landings and probings of the treated membrane were counted during a 5 minute period for the same replicate of mosquitoes. Each formulation was tested against 4 replicates of 25 adult female mosquitoes per replicate, and two different researchers' arms were used as attractants, with one researcher being the attractant for two replicates for each treatment. Mosquito replicates that did not land/probe at least 3 times in the 5 minute control time period were not used for repellency testing. Repellency was calculated as one minus the ratio of the average number of probings or landings using the treated membrane divided by the average number of probings or landings using the untreated membrane from the same cages over the same four replicates of mosquitoes.

Treatments: Formulation #580 is a water-based, negative control formulation that includes an alcohol, a surfactant, an anti-oxidant, an anti-microbial component, but no nootkatone. Formulation #579 is identical to formulation #580, except for the addition of 5% nootkatone and the reduction of water to account for the addition of nootkatone. The positive control for the experiment was a membrane treated with 20% DEET in ethanol.

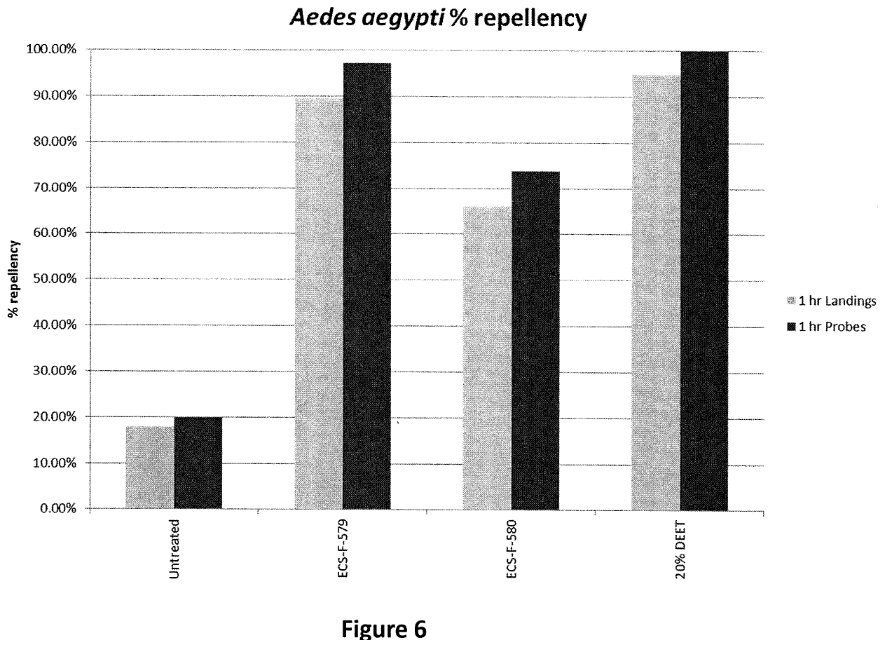

Results. FIG. 6 shows the average repellency of 4 replicates of “arm over cage” testing of formulations 579 and 580 in comparison to an untreated control and 20% DEET in ethanol. Formulation 580 provides roughly 70% repellency against either probings or landings, and formulation 579, with the addition of nootkatone, provides 90% repellency against landings, and 97% repellency against probings (bites).

### Example No. 6

### Efficacy of Additional Exemplar Formulations for Repellency of Adult Mosquitoes

In this example, emulsion or micro-emulsion compositions were formulated to provide contact repellency against adult mosquitoes.

Twenty five Aedes aegypti adult female mosquitoes were introduced into a 1 ft.×1 ft.×1 ft. cage. The mosquitoes were starved for at least 2 hours before repellency testing. The test formulation or control substance (see “Treatments”) was applied at a rate of approximately 0.3 mL onto a dampened collagen membrane (2.5 inches by 6 inches) to mimic the effect of skin, and the membrane was allowed to age for one hour while resting on a damp cloth. An untreated, dampened collagen membrane was placed on a mesh opening at the top of the test cage, and a researcher's arm was suspended ˜1/4 inch above the membrane to act as an attractant. The numbers of landings and probings of the untreated membrane were counted during a 5 minute period, and these counts were used as the baseline level of activity for that specific replicate of mosquitoes. Immediately after the baseline count, an aged, treated membrane was placed on top of the cage, and the numbers of landings and probings of the treated membrane were counted during a 5 minute period for the same replicate of mosquitoes. Each formulation was tested against 4 replicates of 25 adult female mosquitoes per replicate, and two different researchers' arms were used as attractants, with one researcher being the attractant for two replicates for each treatment. Mosquito replicates that did not land/probe at least 3 times in the 5 minute control time period were not used for repellency testing. Repellency was calculated as one minus the ratio of the average number of probings or landings using the treated membrane divided by the average number of probings or landings using the untreated membrane from the same cages over the same four replicates of mosquitoes.

Treatments: Formulation #607 is a water-based, negative control formulation that includes an alcohol, a surfactant, an anti-oxidant, an anti-microbial component, but no nootkatone. Formulation #605 is identical to formulation #607, except for the addition of 1% nootkatone and the reduction of water to account for the addition of nootkatone. The additional formulations have one or more modifications versus formulation #607, but all compositions are water-based emulsion or micro-emulsion formulations that include an alcohol, a surfactant, an anti-oxidant, and an anti-microbial component. The positive control for the experiment was a membrane treated with 20% DEET in ethanol.

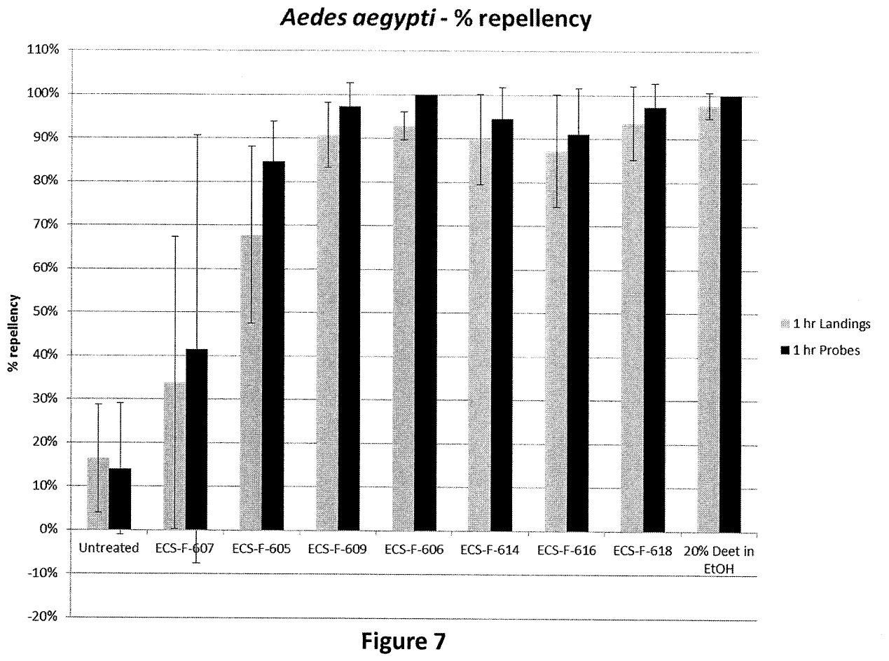

Results. FIG. 7 shows the average repellency of 4 replicates of “arm over cage” testing of formulations 607, 605, 609, 606, 614, 616 and 618 in comparison to an untreated control and to 20% DEET in ethanol. Formulation 607 provides roughly 35-40% repellency against either probings or landings, while formulation 605, with the addition of 1% w/w nootkatone, provides roughly 70% repellency against landings, and 85% repellency against probings (bites). By increasing the nootkatone concentration to 2% w/w in formulation 609 and to 5% w/w in formulation 606, improved landing repellency of 90% and improved probing repellency of 100% was attained, values that are similar to the 20% DEET control. Additional formulations 614, 616, and 618 also provided 90-100% repellency.

### Example No. 7

### Determining Duration of Protection from Larvae by Nootkatone-Containing Formulations

In this example, nootkatone-containing larvicide compositions were formulated to maximize duration of protection by at least one of killing, immobilizing, or repelling larvae. Method: Clean, glass 600 mL beakers were set up as test containers (such that the surface area of water to be treated is 54 cm²), and were treated with formulations such as the ones used in Example 1. Beakers are lightly covered with Kimwipes® (thin nonabrasive tissue towels made of nonwoven extra low lint cellulose fibers) to prevent contamination, and to reduce evaporation. Beakers left untreated were used as negative controls. Four cohorts of 25 3^{rd} and 4^{th} instar larvae were added to individual beakers per day, 3-14 days after treatment, one month after treatment, or two months after treatment with nootkatone, and mortality of larvae was recorded 24 and 48 hours after addition of larvae to beakers.

### Results

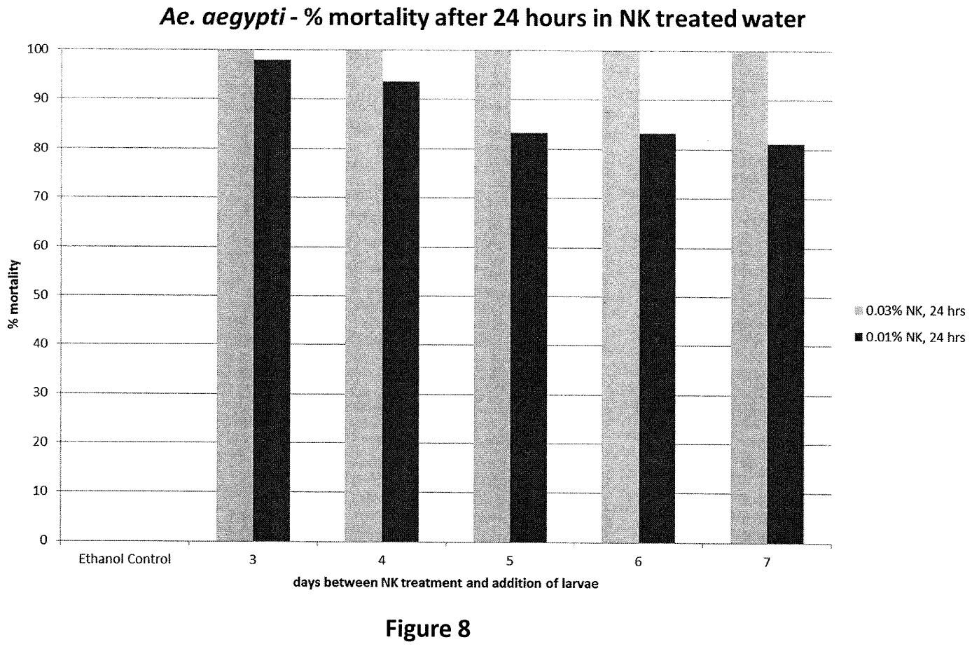

The results shown in FIG. 8 demonstrate that a concentration of 0.03% nootkatone/1% ethanol killed 100% of Aedes aegypti larvae within 24 hours when larvae were added to treated water 3-7 days after the water was treated. Control beakers with 1% ethanol alone exhibited no killing (data not shown). It is believed that formulations such as the ones used in Examples 1-6 will reduce the time to attain 100% mortality, or will extend the effective duration of larvicidal activity, or both.

### Example No. 8

### Efficacy of Exemplar Formulation against Mosquito Pupae and for Preventing Successful Eclosion of Adult Mosquitoes

In this example, nootkatone-containing compositions were formulated to kill mosquito pupae.

Pupae preparation. Eggs of Aedes aegypti or Anopheles quadrimaculatus were purchased from a commercial supplier. Eggs were hatched in sterile MilliQ water and fed with finely ground Tetramin® fish food until they developed into pupae.

Pupae experiments. Clean, glass 600 mL beakers were washed and thoroughly rinsed prior to use as test containers. On testing days, pupae were removed from dishes used to grow larvae. Replicates of 10 pupae each were randomly assigned to glass beakers in a volume of 100 mL of sterile MilliQ water, and a treatment (see “Treatments” below) is added. A minimum of three control replicates and 4 treated replicates were tested on more than one day. The beakers were then covered lightly with Kimwipes®, secured by rubber bands to prevent escape of adults. The beakers were observed after 24 hours, and the numbers of live pupae, dead pupae, live adults, and dead adults were recorded.

Treatments. An aliquot of 0.5-1 mL of formulations such as those used in Example 1 was added to each test beaker. Control beakers consist of 100 mL of sterile MilliQ water.

### Results

In previous testing, it was determined that an average of 94% of pupae treated with 0.03% nootkatone/1% ethanol died within 24 hours (93% in one experiment, 95% on a second day of testing, data not shown), while control beakers treated with 1% ethanol alone experienced a 3% mortality rate. It is anticipated that treatment using formulations such as the ones used in Example 1 will reduce the time to attain 100% mortality, or will extend the effective duration, or both.

### Example No. 9

### Prevention of Adult Emergence from Pupae

In this example, nootkatone-containing compositions were formulated to kill pupae or prevent adult mosquito eclosion.

Pupae preparation. Eggs of Aedes aegypti or Anopheles quadrimaculatus were purchased from a commercial supplier. They were hatched in sterile MilliQ water and fed with finely ground TetraMin® fish food (fish meal, dried yeast, ground brown rice, shrimp meal, wheat gluten, feeding oat meal, fish oil, potato protein, dehulled soybean meal, soybean oil, algae meal, sorbitol, lecithin, monobasic calcium phosphate, ascorbic acid, yeast extract, inositol, niacin, L-ascorbyl-2-polyphosphate, riboflavin-5-phosphate, α-tocopherol-acetate, d-calcium pantothenate, thiamine mononitrate, pyridoxine hydrochloride, vitamin A palmitate, menadione sodium bisulfite complex, biotin, vitamin B12 supplement, cholcalciferol, manganese sulfate monohydrate, zinc sulfate monohydrate, ferrous sulfate monohydrate, cobalt acetate) until they developed into pupae.

Pupae experiments. Clean, glass 600 mL beakers were washed and thoroughly rinsed prior to use as test containers. On each of four testing days, pupae were removed from dishes used to grow larvae. Replicates of 10 pupae each were randomly assigned to glass beakers in a volume of 100 mL of sterile MilliQ water, and a treatment (see “Treatments” below) is added. The beakers are then covered lightly with Kimwipes® and secured by rubber bands to prevent escape of adults. The beakers were observed after 24 hours, and the number of live pupae, dead pupae, live adults, and dead adults were recorded.

Treatments. An aliquot of 0.5-1 mL of formulations such as those used in Example 1 was added to each test beaker. Control beakers consist of 100 mL of sterile MilliQ water.

### Results

In previous testing, pupae contained in control beakers containing 0.5% ethanol in water gradually eclosed over 48 hours, and after 48 hours, 81.8% of the pupae had become adults that were either flying or resting on the surface of the water or portions of the interior of the beakers, while pupae held in the presence of 0.015% nootkatone/0.5% ethanol (v/v) in water for 48 hours, had no surviving adults (data not shown).

### Example No. 10

### Efficacy of Exemplar Formulation for Reducing Mosquito Egg Hatching

In this example, compositions are formulated to prevent hatching of mosquito eggs.

Egg preparation. Mosquito eggs from Aedes aegypti and Anopheles quadrimaculatus mosquitoes are obtained from a commercial source.

Egg hatching experiments. Anopheles quadrimaculatus or Aedes aegypti eggs are divided into equal cohorts of ˜100-500 eggs. Each cohort is placed inside a 9 cm Petri dish after receiving a treatment (see “Treatments”), after which the Petri dish is covered and held at 30-35° C. to allow hatching. Hatching is scored as the number of larvae present after 24-48 hours. Four cohorts are tested per treatment.

Treatments. An aliquot of 0.1-0.2 mL of formulations such as those used in Example 1 is added to 20 mL of sterile MilliQ water in each treatment Petri dish. Control Petri dishes consist of 20 mL of sterile MilliQ water. Alternatively, the treatment consists of a non-liquid formulation, such as a brick, puck or powder.

Results. The rate of egg hatching is calculated for each treatment and control egg cohort, and the results of at least 4 cohorts are averaged, and used to calculate the relative hatch rate for treatments versus controls. It is anticipated that treatment using formulations such as the ones used in Example 1 will reduce the proportion of eggs that hatch.

### Example No. 11

### Prevention of Adult Mosquito Egg Laying on Treated Mosquito Breeding Sites

In this example, compositions are formulated to prevent adult female mosquitoes from landing on a breeding site to lay eggs.

Mosquito Preparation. Eggs are obtained from a commercial source, hatched in sterile MilliQ® water, and fed finely ground Tetramin® fish food until they develop into pupae. Pupae are isolated from larvae, and are transferred by pipet into Petri dishes. The Petri dishes are introduced into 1 cubic foot insect cages to allow the adults to eclose and leave the surface of the water. Adult mosquitoes are fed 10% glucose on cotton balls for 4 days after eclosion, then the mosquitoes are starved for 16-24 hours. Female mosquitoes are fed a blood meal. The blood meal can be administered using a blood feeding apparatus containing of sterile bovine blood, such as that used in Koou, et al. (“A novel mosquito feeding system for routine blood-feeding of Aedes aegypti and Aedes albopictus,” Tropical Biomedicine, 29(1): 169-74, 2012). After administration of the blood meal, the female mosquitoes are observed to assure that the abdominal region is engorged with blood. Suitable egg laying sites are provided (see “Treatments” below).

Treatments. Two Petri dishes are fitted with white filter paper, and the dishes are added to the cage of blood fed mosquitoes. Approximately 20 mL of liquid is added to each Petri dish to provide a suitable egg laying site. Control dishes contain sterile MilliQ® water. Treatment dishes contain sterile MilliQ® water to which is added 0.1-0.2 mL of a formulation such as one of the formulations used in Example 1. Cages are observed cages at 24 hours and 48 hours after the blood meal. The experiment is performed in triplicate.

### Results

Female mosquitoes lay a high density of eggs (black spots) on suitable egg laying substrates, such as white filter paper. It is anticipated that either adult females will be repelled from egg laying sites that are treated with the treatment formulation(s), or that they attempt to land and will be poisoned by contacting the treatment formulation on the water surface. The rate of egg laying on the treated surface and the control surface, as well as the presence of any adults found dead on the surface, as well as the overall mortality rate on a daily basis will be recorded.

### Example No. 12

### Efficacy of Nootkatone Residue in Killing Adult Mosquitoes due to Contact with Treated Non-Porous Surfaces

In this example, residues of nootkatone-containing compositions were tested for the ability to kill adult mosquitoes after contact of mosquitoes with treated non-porous surfaces.

Method: Nootkatone was solubilized in acetone to a concentration of 1%, 0.607%, 0.368%, 0.224%, 0.136%, 0.082%, and 0.05%. 0.5 mL of solution was dispensed into a 5 cm diameter glass Petri dish for each replicate to be tested, using a fume hood and appropriate personal protective equipment. Liquid was dispensed to ensure that the entire base of the dish was covered with solution. Dishes were transferred to an orbital shaker set at a speed of 200 revolutions per minute. The dishes were shaken for 15 minutes to ensure even distribution on the surface of the plate. Control dishes were prepared in the same way using 0.5 mL of acetone without nootkatone. Dishes were allowed to dry for 4 hours before use. Dishes were stored at 4° C. until use. Groups of 10 adult female mosquitoes, 2-5 days old, were gently aspirated into a transfer pot system, and were then gently tapped out onto the surface of the treated or control Petri dishes. Although attempts are made to have groups of exactly 10 mosquitoes, group size could vary. Groups of more than 15 mosquitoes were excluded from testing, due to overcrowding. The opening to the dishes through which the mosquitoes were introduced was covered with parafilm to prevent escape. After 30 minutes of exposure to the Petri dishes, mosquitoes were transferred to paper cups for additional observation. They were supplied with 10% sucrose solution ad libitum. Three replicates, or 30 total adult female mosquitoes were tested for each concentration of nootkatone in acetone, and for the acetone-only controls. The mosquitoes tested were either the Aedes aegypti New Orleans strain, or Anopheles gambiae Kisumu strain.

Observation Methods:
a. The number of “Alive”, “Knockdown (KD)”, and “Dead” Insects per arena was recorded prior to applications (Pre-trt), and at 30 minutes, and 24 hr after the exposure period.
   i. Definitions of “Alive”, “Knockdown (KD)”, and “Dead” are as defined above.

### Results

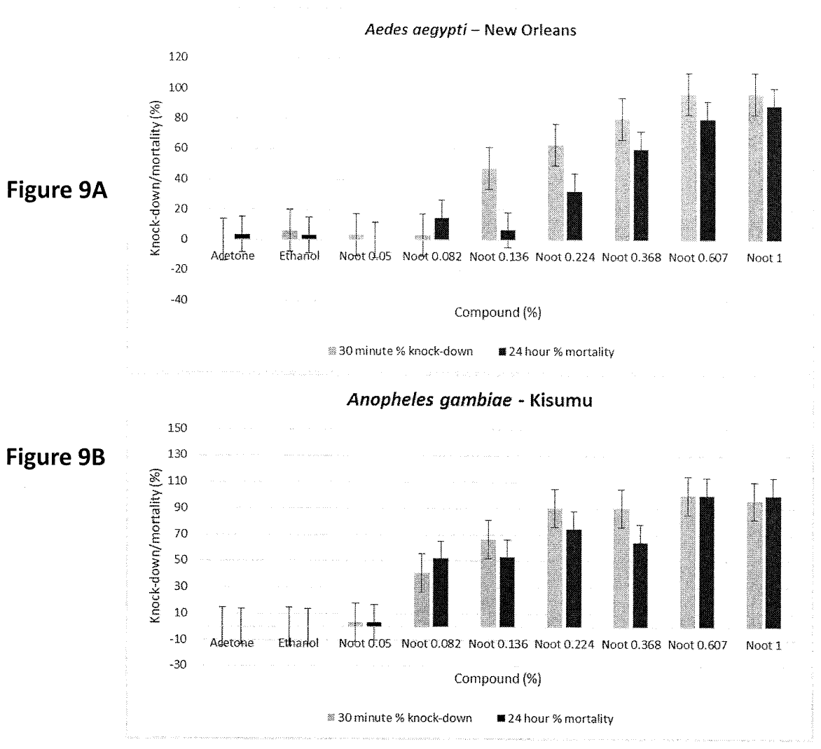

The results shown in FIG. 9A demonstrate that a concentration of 0.136% nootkatone knocked down 47% of Aedes aegypti adults within 30 minutes, and the percentage of knockdown was concentration dependent. A concentration of 0.224% nootkatone was required to obtain significant mortality at 24 hours after treatment, and 89% mortality was achieved at a concentration of 1% nootkatone. Control dishes with acetone or ethanol alone exhibited less than 5% killing.

The results shown in FIG. 9B demonstrate that a concentration of 0.082% nootkatone knocked down 41% of Anopheles gambiae adults within 30 minutes, and the percentage of knockdown was concentration dependent. The same 0.082% concentration of nootkatone was sufficient to obtain kill 50% of the Anopheles gambiae adults at 24 hours after treatment, and 100% mortality was achieved at a concentration of both 0.607% and 1% nootkatone. Control dishes with acetone or ethanol alone exhibited no killing.

### Example No. 13

### Efficacy of Nootkatone Residue in Killing Adult Insects due to Contact with Treated Porous Surfaces

In this example, residues of nootkatone-containing compositions were tested for the ability to kill adult insects after contact of mosquitoes with treated porous surfaces.

Method: Nootkatone was solubilized in ethanol to a concentration of 1% w/v. The nootkatone solution, or solvent (ethanol) alone as a negative control, was applied directly to filter paper using a micropipette, in an amount of 1 mL for a 9 cm filter paper disc. Filter papers were allowed to dry completely before being cut to the appropriate size prior to the start of the test. Treated and untreated filter papers were cut so that they covered the bottom of a suitable container for each test species (see Table No. 4, below). At each observation period, arthropods were classified as alive, knocked down (KD) or dead.

TABLE NO. 4
Treatment Arenas.
Table No. 4. Treatment arenas

| | | | Maximum |
|---|---|---|---|
| | | | assessment |
| Species | Treatment(s) | Treatment container | time |
| Aphids | 1% Nootkatone | Barley covered with test | 24 |
| | | tube | |
| Deer ticks | 1% Nootkatone | 2.5″ filter paper | 72 |
| | | envelopes | |
| Dust mites | 1% Nootkatone | 2.5″ filter paper | 72 |
| | | envelopes | |
| Fire ants | 1% Nootkatone | 9 cm petri dish | 24 |
| Midges | 1% Nootkatone | 9 cm petri dish w/ | 24 |
| | | inverted cup | |
| Termites | 1% Nootkatone | Glass tube w/ screen | 72 |
| | | ends | |
| Asian tiger | 1% Nootkatone | 9 cm petri dish w/ | 48 |
| mosquito | | inverted cup | |
| Yellow fever | 1% Nootkatone | 9 cm petri dish w/ | 24 |
| mosquito | | inverted cup | |
| Southern | 1% Nootkatone | 9 cm petri dish w/ | 24 |
| house | | inverted cup | |
| mosquito | | | |
| Common | 1% Nootkatone | 9 cm petri dish w/ | 24 |
| malaria | | inverted cup | |
| mosquito | | | |

Observation Methods:
a. The number of “Alive”, “Knockdown (KD)”, and “Dead” Insects per arena was recorded prior to applications (Pre-trt), and at 30 minutes, and 24 hr after the exposure period.
b. Definitions of “Alive”, “Knockdown (KD)”, and “Dead” are as defined above.

### Results

The results shown in Table No. 5 demonstrate that a concentration of 1% nootkatone killed 100% of yellow fever mosquitoes (Aedes aegypti) adults within 24 hours, and 98% of Asian tiger mosquitoes (Aedes albopictus), 98% of southern house mosquitoes (Culex quinquefasciatus) and 98% of common malaria mosquitoes (Anopheles quadrimaculatus) were also killed within 24 hours. A 1% concentration of nootkatone also killed 100% of biting midges and fire ants, and 94% of aphids, within 24 hours. Dust mites were only evaluated at the final 72 hour observation point due to the difficulty of being able to open and reseal the test arena without loss of insects, and all were killed at that point. Termites reached 90% mortality after 72 hours of exposure to nootkatone residue.

TABLE NO. 5
Percent mortality at 72 hours for pest species treated with 1%
nootkatone.

| Species | Mortality % |
|---|---|
| Yellow fever | 100 |
| mosquito* | |
| Biting midge* | 100 |
| Dust mite | 100 |
| Fire ant | 100 |
| Asian tiger | 98 |
| mosquito* | |
| Southern house | 98 |
| mosquito* | |
| Deer tick | 98 |
| Common malaria | 98 |
| mosquito* | |
| Aphid* | 94 |
| Termite | 90 |

*Mortality reached at 24 hours

### Example No. 14

### Efficacy of Residue from Emulsions or Micro-Emulsions in Killing Adult Mosquitoes due to Contact with Treated Non-Porous Surfaces

In this example, residues of emulsion and micro-emulsion compositions are tested for the ability to kill adult mosquitoes after contact of mosquitoes with treated surfaces. Method: 0.5 mL of an emulsion or micro-emulsion is dispensed into a 5 cm diameter glass Petri dish for each replicate to be tested, using a fume hood and appropriate personal protective equipment. Liquid is dispensed to ensure that the entire base of the dish is covered with solution. Dishes are transferred to an orbital shaker set at a speed of 200 revolutions per minute. The dishes are shaken for 15 minutes to ensure even distribution on the surface of the plate. Control dishes are prepared in the same way using 0.5 mL of solvent without nootkatone. Dishes are allowed to dry for a minimum of 4 hours before use. Dishes are stored at 4° C. until use. Groups of 10 adult female mosquitoes, 2-5 days old, are gently aspirated into a transfer pot system, and are then gently tapped out onto the surface of the treated or control Petri dishes. Although attempts are made to have groups of exactly 10 mosquitoes, group size could vary. Groups of more than 15 mosquitoes are excluded from testing, due to overcrowding. The opening to the dishes through which the mosquitoes are introduced is covered with parafilm to prevent escape. After 30 minutes of exposure to the Petri dishes, mosquitoes are transferred to paper cups for additional observation. They are supplied with 10% sucrose solution ad libitum. Three replicates or 30 total adult female mosquitoes are tested for each emulsion or micro-emulsion, and for the solvent-only controls. The mosquitoes tested are either an Aedes aegypti strain, or an Anophles gambiae strain.

Observation Methods:
a. The number of “Alive”, “Knockdown (KD)”, and “Dead” Insects per arena was recorded prior to applications (Pre-trt), and at 30 minutes, and 24 hr after the exposure period.
b. Definitions of “Alive”, “Knockdown (KD)”, and “Dead” are as defined above.

### Results

We have, in Example No. 12, demonstrated that deposition of nootkatone onto a glass surface produces concentration-dependent killing of two mosquito species within 24 hours after 30 minutes of exposure to nootkatone residues. We anticipate that residues of nootkatone left behind after evaporation of nootkatone-containing emulsions or micro-emulsions will, likewise, produce killing of mosquitoes that are exposed for similar time periods. We anticipate that control dishes with solvent alone will exhibit 0-5% killing.

### Example No. 15

### Efficacy of Nootkatone Residue in Killing Adult Insects due to Dontact with Treated Porous Surfaces

In this example, residues of nootkatone-containing compositions are tested for the ability to kill adult insects after contact of mosquitoes with treated porous surfaces.

Method: Nootkatone is solubilized in ethanol to a concentration of 1% w/v. The nootkatone solution, or solvent alone as a negative control, is applied directly to filter paper using a micropipette, at a rate of 1 mL for a 9 cm filter paper disc. Filter papers are allowed to dry completely before being cut to the appropriate size prior to the start of the test. Treated and untreated filter papers are cut so that they cover the bottom of a suitable container for each test species (at minimum, deer ticks and mosquitoes). At each observation period, arthropods are classified as alive, knocked down (KD) or dead, as defined herein elsewhere.

### Results

In Example No. 13, it was demonstrated that deposition of nootkatone onto a porous filter paper surface produces killing of four mosquito species within 24 hours of exposure to nootkatone residues. Deer ticks were only evaluated at one time point, but they were killed within 72 hours. It is anticipated that residues of nootkatone left behind after evaporation of nootkatone-containing emulsions or micro-emulsions will, likewise, produce killing of mosquitoes or ticks that are exposed for similar time periods. Control filter papers with solvent alone are anticipated to exhibit 0-5% killing.

### Example No. 16

### Efficacy of Addition of Enhancers to Exemplar Formulations for Repellency of Adult Mosquitoes

In this example, emulsion or micro-emulsion compositions containing nootkatone and an enhancer were formulated to provide contact repellency against adult mosquitoes. Twenty five Aedes aegypti adult female mosquitoes were introduced into a 1 ft.×1 ft.×1 ft. cage. The mosquitoes were starved for at least 2 hours before repellency testing. The test formulation or control substance (see “Treatments”) was applied at a rate of approximately 0.3 mL onto a dampened collagen membrane (2.5 inches by 6 inches) to mimic the effect of skin, and the membrane was allowed to age for one hour while resting on a damp cloth. An untreated, dampened collagen membrane was placed on a mesh opening at the top of the test cage, and a researcher's arm was suspended ˜1/4 inch above the membrane to act as an attractant. The numbers of landings and probings of the untreated membrane were counted during a 5 minute period, and these counts were used as the baseline level of activity for that specific replicate of mosquitoes. Immediately after the baseline count, an aged treated membrane was placed on top of the cage, and the numbers of landings and probings of the treated membrane were counted during a 5 minute period for the same replicate of mosquitoes. Each formulation was tested against 4 replicates of 25 adult female mosquitoes per replicate, and two different researchers' arms were used as attractants, with one researcher being the attractant for two replicates for each treatment. Mosquito replicates that did not land/probe at least 3 times in the 5 minute control time period were not used for repellency testing. Repellency was calculated as one minus the ratio of the average number of probings or landings using the treated membrane divided by the average number of probings or landings using the untreated membrane from the same cages over the same four replicates of mosquitoes.

Treatments: Formulation #605 is a water-based formulation that includes an alcohol, a surfactant, an anti-oxidant, an anti-microbial component, and is a 1% w/w nootkatone control for the experiment. Formulations #624-628 are identical to formulation #605, except for the addition of 1% of a potential enhancer and the reduction of water to account for the addition of the enhancer. The positive control for the experiment was a membrane treated with 20% DEET in ethanol.

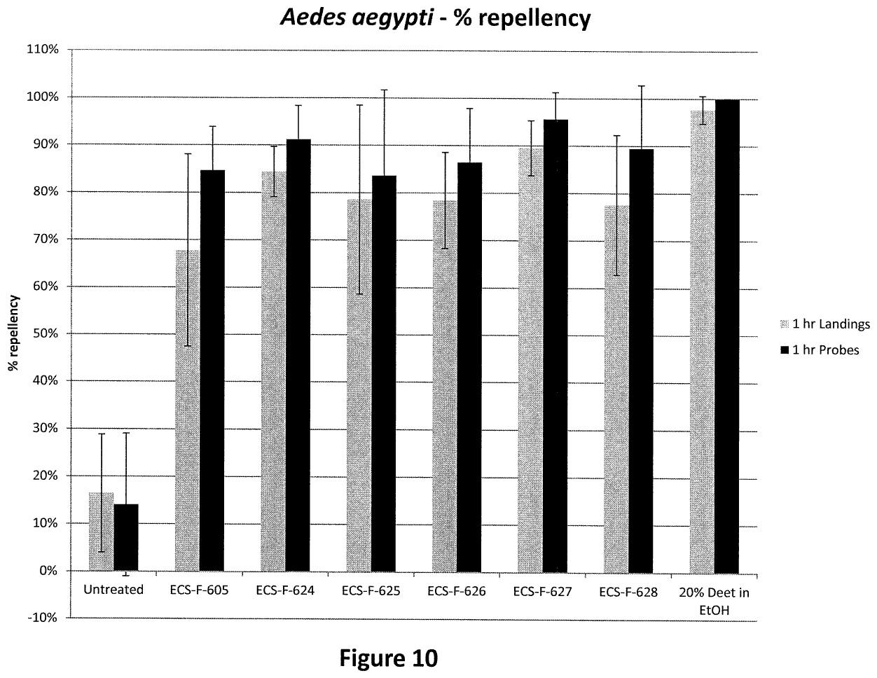

Results: FIG. 10 shows the average repellency of 4 replicates of “arm over cage” testing of formulations 605, and 624-628 in comparison to an untreated control and to 20% DEET in ethanol. Formulation 605 comprised of 1% w/w nootkatone, provides 68% repellency against landings, and 85% repellency against probings (bites). By addition of 1% w/w of one of five potential enhancers in formulations 624 through 628, landing repellency improved by approximately 10%, to 78-79%, in formulations 625, 626, and 628. Landing repellency improved to 84% in formulation 624, and to 90% in formulation 627. Probing repellency of 96% was attained using formulation 627.

### Example No. 17

### Emulsion and Micro-Emulsion Particle Size Determination

In this example, compositions are tested for their particle size distributions.

Method: Particle sizes are measured using a Malvern Mastersizer 2000s. The sample is dispensed into the sample dispersion unit with a plastic disposable pipette until the laser obscuration is within the set limits or until 3 mL is dispensed. For the measurement of samples, the instrument parameters are as follows:
Pre-Measurement Delay: 15 seconds
Obscuration Limits Low: 7%
High: 15%
Measurement time: 15 seconds
Measurement Snaps: 15000
Background Time: 15 seconds
Background Snaps: 15000
Pump/Stir Speed: 2500 rpm
Ultrasonics: None
Measurement Cycles: 1 aliquot per sample 3 measurements per aliquot
Laser Specifications: Red (wavelength 633 nm) Blue (wavelength 466 nm)

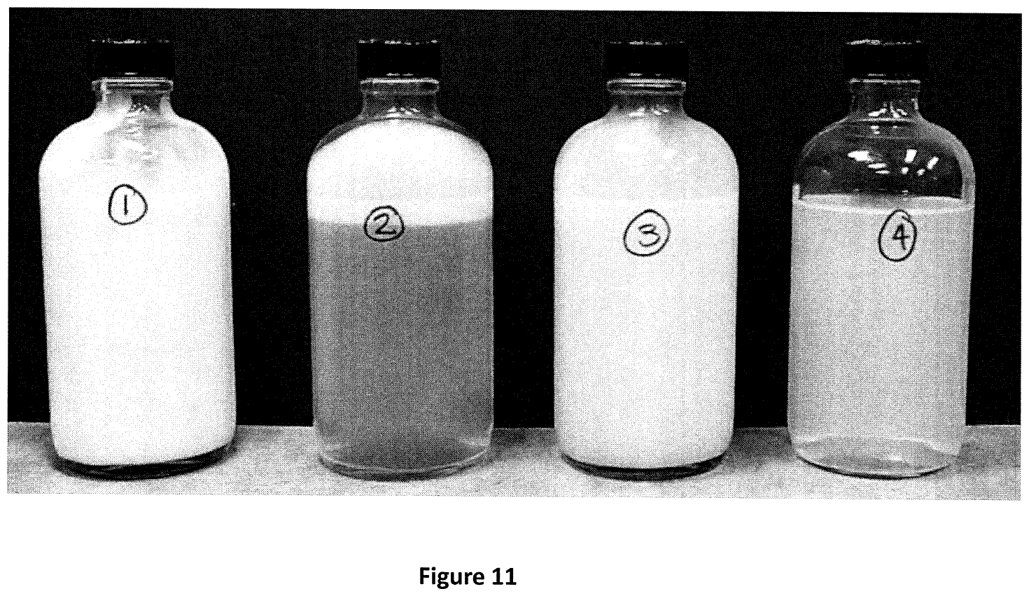

Results: For each emulsion under test, a particle size distribution table such as the example in Table No. 6 is generated. The particle size distribution is expressed as percentages of the measured particles achieving a certain size of particle, i.e., diameter measured in microns. Compositions resulting in standard emulsions have particle size distributions similar to ECS-36-174-1 through ECS-36-174-3. Compositions resulting in micro-emulsions have particle size distributions similar to ECS-36-174-4. FIG. 11 provides visual distinction between the opacity found in a standard emulsion such as examples ECS-36-174-1 through ECS-36-174-3, as compared to the translucent characteristic of micro-emulsion ECS-36-174-4.

TABLE NO. 6
Summary of Particle Size Measurements.

| | | | | ECS- |
|---|---|---|---|---|
| | ECS-36-174-1 | ECS-36-174-2 | ECS-36-174-3 | 36-174-4 |
| ≤10% | 0.08 μm | 0.14 μm | 0.01 μm | 0.07 μm |
| ≤50% | 0.18 μm | 1.07 μm | 1.61 μm | 0.10 μm |
| ≤80% | 0.34 μm | 1.66 μm | 3.69 μm | 0.12 μm |
| ≤90% | 0.62 μm | 2.02 μm | 4.99 μm | 0.14 μm |
| ≤99% | 4.91 μm | 2.90 μm | 8.59 μm | 0.19 μm |

### Example No. 18

### Efficacy of Additional Exemplar Formulations for Repellency of Adult Mosquitoes

In this example, emulsion or micro-emulsion compositions were formulated to provide contact repellency against adult mosquitoes.

Twenty five Aedes aegypti adult female mosquitoes were introduced into a 1 ft×1 ft×1 ft cage. The mosquitoes were starved for at least 2 hours before repellency testing. The test formulation or control substance (see “Treatments”) was applied at a rate of approximately 0.3 mL onto a dampened collagen membrane (2.5 inches by 6 inches) to mimic the effect of skin, and the membrane was allowed to age for one hour while resting on a damp cloth. An untreated, dampened collagen membrane was placed on a mesh opening at the top of the test cage, and a researcher's arm was suspended -1/4 inch above the membrane to act as an attractant. The numbers of landings and probings of the untreated membrane were counted during a 5 minute period, and these counts were used as the baseline level of activity for that specific replicate of mosquitoes. Immediately after the baseline count, an aged, treated membrane was placed on top of the cage, and the numbers of landings and probings of the treated membrane were counted during a 5 minute period for the same replicate of mosquitoes. Each formulation was tested against 4 replicates of 25 adult female mosquitoes per replicate, and two different researchers' arms were used as attractants, with one researcher being the attractant for two replicates for each treatment. Mosquito replicates that did not land/probe at least 3 times in the 5 minute control time period were not used for repellency testing. Repellency was calculated as one minus the ratio of the average number of probings or landings using the treated membrane divided by the average number of probings or landings using the untreated membrane from the same cages over the same four replicates of mosquitoes.

Treatments: Formulation #666 is a water-based, negative control formulation that includes an alcohol, a surfactant, an anti-oxidant, an anti-microbial component, but no nootkatone, no co-solvent alcohol, and no geraniol enhancer (see Table No. 2). Formulations #660-665 have the components of #666, with the addition of 2% nootkatone, either benzyl alcohol or dodecanol as a co-solvent, varying concentrations of enhancer geraniol, and the reduction of water to account for the addition of nootkatone, co-solvent, and enhancer. Formulations 660-665 have one or more modifications versus formulation #666, but all compositions are water-based emulsion or micro-emulsion formulations that include an alcohol, a surfactant, an anti-oxidant, and an anti-microbial component. The positive control for the experiment was a membrane treated with 20% DEET in ethanol.

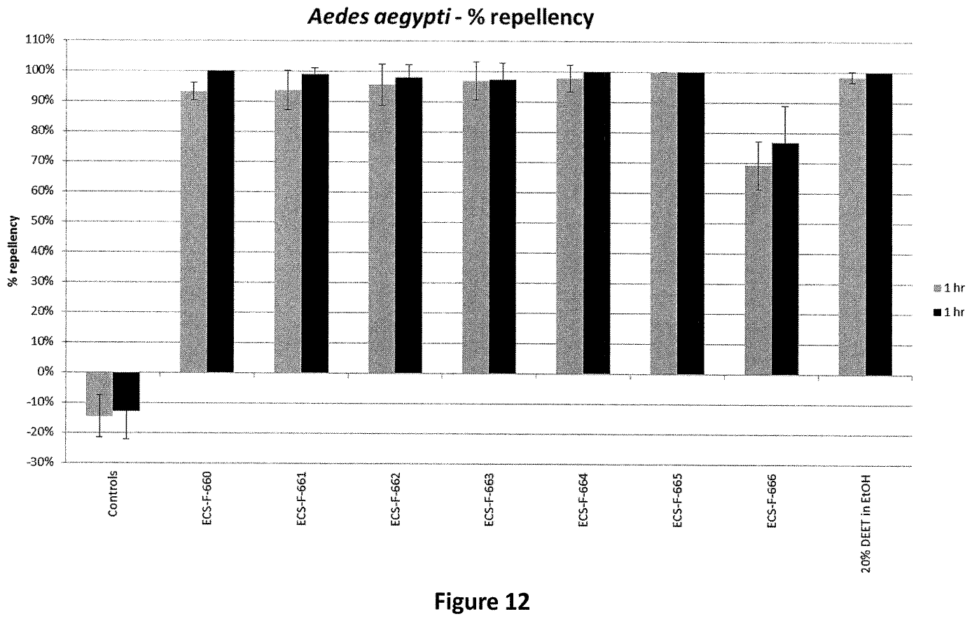

Results. FIG. 12 shows the average repellency of 4 replicates of “arm over cage” testing of formulations 660-666 in comparison to an untreated control and 20% DEET in ethanol. Formulation 666 provides roughly 70-75% repellency against either probings or landings, while formulations 660-665, with the addition of 2% w/w nootkatone, 4% co-solvent, and 1-4% geraniol as enhancer, all provide greater than 90% repellency against landings, and greater than 95% repellency against probings (bites). Formulation 665 provided 100% repellency against both landings and probings (bites), while the positive control, 20% DEET in ethanol, provided 98% repellency against landings and 100% repellency against bites.

Having described the invention in detail and by reference to specific aspects and/or embodiments thereof, it will be apparent that modifications and variations are possible without departing from the scope of the invention defined in the appended claims. More specifically, although some aspects of the present invention may be identified herein as particularly advantageous, it is contemplated that the present invention is not limited to these particular aspects of the invention. Percentages disclosed herein can vary in amount by ±10, 20, or 30% from values disclosed and remain within the scope of the contemplated invention.

What is claimed is:

1. An emulsion suitable for use as a pesticide or pest repellent, comprising:
(a) between about 6% and about 99% w/w hydrophobic solvent;
(b) between about 4% and about 99% w/w hydrophilic solvent;
(c) between about 1% and about 30% w/w surfactant; and
(d) between about 0% and about 99% w/w water.

2. An emulsion according to claim 1, wherein the emulsion comprises:
(a) between about 6% and about 25% w/w hydrophobic solvent;
(b) between about 5% and about 20% w/w hydrophilic solvent;
(c) between about 10% and about 20% w/w surfactant; and
(d) between about 60% and about 80% w/w water,
wherein the emulsion is a micro-emulsion capable of killing and/or repelling at least 90% of a target pest population or ectoparasite selected from at least one of a nematode, a mosquito, a gnat, a house fly, a horse fly, a tick, a tsetse fly, a blowfly, a screw fly, a bed bug, a flea, a louse, a sea louse, a fish louse, an aphid, a thrip, an arachnid, a termite, a silverfish, an ant, a cockroach, a locust, a fruit fly, a wasp, a hornet, a yellow jacket, a scorpion, a chigger, a mite or a dust mite.

3. An emulsion according to claim 1 or 2, wherein the hydrophobic solvent is at least one of a paraffinic and/or an iso-paraffinic hydrocarbon, isopropyl myristate, isopropyl palmitate, pentyl propionate, and a methyl ester of vegetable oil.

4. An emulsion according to any of claims 1 to 3, wherein the hydrophilic solvent is at least one of an isopropyl alcohol, ethanol, methanol, octyl alcohol, decyl alcohol, tetrahydrofurfuryl alcohol, benzyl alcohol, a glycol, glycerol, propylene carbonate, N-methyl pyrrolidone, g-butyrolactone and dipropylene glycol monomethyl ether.

5. An emulsion according to any of claims 1 to 4, wherein the surfactant comprises a non-ionic emulsifier that is at least one of castor oil ethoxylate, alcohol ethoxylate, glycol ethoxylate, lanolin ethoxylate, fatty acid ethoxylate, sorbitan esters of fatty acids, alkyl dimethyl amine oxides, alkyl phenol ethoxylates, alkyl ether ethoxylates and alkyl glucosides, or a blend of the at least one non-ionic emulsifier with at least one ionic emulsifier selected from sodium lauryl sulfate, sodium dodecylbenzene sulfonate, sodium laureth sulfate, sodium dioctyl sulfosuccinate, metal salts of nonylphenol ethoxylate sulfate, ammonium nonylphenol ethoxylate sulfate, nonylphenol POE 10 phosphate ester, diethanolamine alkyl sulfate and triethanolamine alkyl sulfate.

6. An emulsion according to any of claims 1 to 5, further comprising at least one of a preservative, an antioxidant, a co-solvent or a co-surfactant.

7. An emulsion according to any of claims 1 to 6, further comprising a sesquiterpene or a derivative thereof.

8. An emulsion according to any of claims 1 to 3, wherein the emulsion further comprises nootkatone or a derivative thereof in an amount at between about 0.01% w/w and about 20% w/w.

9. An emulsion according to any of claims 1 to 3, further comprising a viscosity modifier.

10. An emulsion according to any of the preceding claims further comprises an enhancer or a derivative thereof in an amount between about 1% w/w and about 5% w/w.

11. An emulsion according to claim 10, wherein the enhancer comprises one or more of rosemary oil, peppermint oil, 2-phenethyl proprionate, geraniol, and lemongrass oil.

12. An emulsion according to claim 11, wherein the emulsion comprises geraniol in an amount of about 4% w/w.

13. A method of treating or preventing pest or ectoparasite infestation, comprising applying the emulsion of any of claims 1 to 12 to a surface.

14. The method of claim 13, wherein the surface comprises at least one of a plant, a portion of a plant, a harvested plant material, skin, hair, fur, scales, feathers, an article of clothing, a collar, a shoe, furniture, bedding, a net, a table, a bench, a desk, a pathway, a carpet, a floor board, a head board, a curtain, a window sill, a mantelpiece, a work surface, a door, a wall molding, a wall, a sheet of glass, or any surface of a vehicle, a tent, a wall, a floor, a waste bin, a water surface, an edge of a water body, or a surface of an object that can create a pool of water.

15. A method according to any of claim 13 or 14, wherein the pest or ectoparasite is at least one of a nematode, a mosquito, a gnat, a horse fly, a tick, a tsetse fly, a blowfly, a screw fly, a bed bug, a flea, a louse, a sea louse, an fish louse, an aphid, a thrip, an arachnid, a termite, a silverfish, an ant, a cockroach, a locust, a fruit fly, a wasp, a hornet, a yellow jacket, a scorpion, a chigger, a mite or a dust mite.

16. A method according to any of claim 13 or 14, wherein the emulsion is applied to the area, surface, object, pest breeding site, or material by an aerosol container with a spray nozzle, a spray gun, a pump sprayer, a trigger sprayer, a pressurized spraying device, a sponge, a brush, a roller, an irrigation spray, or a crop duster helicopter or airplane.

17. Use of an emulsion according to any of claims 1 to 12 to repel, knock-down, paralyze, kill or cause a lack of progression into at least one stage of the life cycle of a pest or ectoparasite.

18. Use of an emulsion according to any of claims 1 to 12 to repel, knock-down, paralyze, kill or cause a lack of progression into at least one stage of the life cycle of a pest or ectoparasite, wherein said pest or ectoparasite is selected from at least one of a nematode, a mosquito, a gnat, a horse fly, a tick, a tsetse fly, a blowfly, a screw fly, a bed bug, a flea, a louse, a sea louse, an aphid, a thrip, an arachnid, a termite, a silverfish, an ant, a cockroach, a locust, a fruit fly, a wasp, a hornet, a yellow jacket, a scorpion, a chigger, a mite or a dust mite.

19. Use of an emulsion according to claim 8 wherein the emulsion or micro-emulsion comprising nootkatone or a derivative thereof causes repellence, knock-down, paralysis, death, or lack of progression into at least one stage of the life cycle of the pest or ectoparasite within the first minute of application, and wherein following evapouration of the solvents, surfactants and water of the composition from the treated surface or object, the nootkatone remaining on the treated surface or object causes repellence, knock-down, paralysis, death, or lack of progression into at least one stage of the life cycle of the pest or ectoparasite for at least 10 days following application of the emulsion or micro-emulsion comprising nootkatone.
